(19) United States
(12) Patent Application Publication
(10) Pub. No.: US 2014/0055726 A1
(43) Pub. Date: Feb. 27, 2014

(54) LIQUID CRYSTAL DISPLAY AND MANUFACTURING METHOD THEREOF

(71) Applicant: SAMSUNG DISPLAY CO., LTD., Yongin-city (KR)

(72) Inventors: Se Hyoung CHO, Seoul (KR); Joon-Chu GOH, Hwaseong-si (KR); Sun Hwa LEE, Andong-si (KR); Jae Keun LIM, Suwon-si (KR); Mee Hye JUNG, Suwon-si (KR); Chong Chul CHAI, Seoul (KR)

(73) Assignee: Samsung Display Co., Ltd., Yongin-city (KR)

(21) Appl. No.: 13/826,975

(22) Filed: Mar. 14, 2013

(30) Foreign Application Priority Data
Aug. 21, 2012 (KR) 10-2012-0091220

(51) Int. Cl. G02F 1/1343; G02F 1/1333

(52) U.S. Cl. CPC G02F 1/134309; G02F 1/1333
USPC 349/106; 349/139; 349/110; 445/24

(57) ABSTRACT

The present invention relates to a liquid crystal display including: an insulation substrate; a microcavity formed on the insulation substrate; a pixel electrode and a common electrode formed in the microcavity on the insulation substrate; and a liquid crystal layer position in the microcavity, and a manufacturing method thereof.

### CROSS-REFERENCE TO RELATED APPLICATION

This application claims priority to and the benefit of Korean Patent Application No. 10-2012-0091220, filed on Aug. 21, 2012, which is hereby incorporated by reference for all purposes as if fully set forth herein.

### BACKGROUND

1. Field

Exemplary embodiments of the present invention relate to a liquid crystal display and a manufacturing method thereof, and in detail, relates to a liquid crystal display having a liquid crystal layer formed inside a microcavity and a manufacturing method thereof.

2. Discussion of the Background

A liquid crystal display panel, which is one of the more common types of flat is panel displays currently in use, includes two substrates with field generating electrodes, such as a pixel electrode and a common electrode, and a liquid crystal layer interposed there between.

The liquid crystal display generates electric fields in the liquid crystal layer by applying voltages to the field generating electrodes, determines the alignment of liquid crystal molecules of the liquid crystal layer by using the generated electric fields, and controls the polarization of incident light, thereby displaying images.

A liquid crystal display having an embedded microcavity (EM) structure is a display device manufactured by forming a sacrificial layer with a photoresist, coating a support member thereon, removing the sacrificial layer by an ashing process, and filing a liquid crystal in an empty space formed by removing the sacrificial layer. However, a common electrode is formed on the sacrificial layer and is positioned close to the data line at a portion where the sacrificial layer is not formed, such that coupling occurs due to parasitic capacitance along with the data line. As a result, the data signal may be delayed.

The above information disclosed in this Background section is only for enhancement of understanding of the background of the invention and therefore it may contain information that does not form the prior art that is already known in this country to a person of ordinary skill in the art.

### SUMMARY

Exemplary embodiments of the present invention provide a display device without a delay of a data signal due to coupling between a data line and a common electrode, and a manufacturing method thereof.

Additional features of the invention will be set forth in the description which follows, and in part will be apparent from the description, or may be learned by practice of the invention.

A display device, according to an exemplary embodiment of the present invention includes: an insulation substrate; a microcavity formed on the insulation substrate; a pixel electrode and a common electrode formed in the microcavity on the insulation substrate; and a liquid crystal layer positioned in the microcavity.

A manufacturing method of a liquid crystal display, according to an exemplary embodiment of the present invention, includes: forming a pixel electrode and a common electrode on an insulation substrate; forming a sacrificial layer on the pixel electrode and the common electrode; forming a roof layer on the sacrificial layer; forming a liquid crystal injection hole; removing the sacrificial layer through the liquid crystal injection hole to form a microcavity; and injecting a liquid crystal into the microcavity.

As described above, the common electrode is formed with the same layer as the pixel electrode such that coupling generated by the overlapping of the data line and the common electrode may be eliminated.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to is explain the principles of the invention.

FIG. 1 is a cross-sectional view of a liquid crystal display according to an exemplary embodiment of the present invention.

FIGS. 2, 3, 4, 5, 6, and 7 are cross-sectional views according to a manufacturing sequence of the liquid crystal display of FIG. 1.

FIG. 8 is a flowchart of a manufacturing method of a liquid crystal display according to an exemplary embodiment of the present invention.

FIG. 9 is a cross-sectional view of a liquid crystal display according to another exemplary embodiment of the present invention.

FIGS. 10, 11, 12, and 13 are cross-sectional views according to a manufacturing sequence of the liquid crystal display of FIG. 9.

FIG. 14 is a flowchart of a manufacturing method of a liquid crystal display according to an exemplary embodiment of the present invention.

FIG. 15 is a cross-sectional view of a liquid crystal display according to another exemplary embodiment of the present invention.

FIG. 16 is a cross-sectional view of a liquid crystal display according to another exemplary embodiment of the present invention.

FIG. 17 is a layout view of a pixel structure of a liquid crystal display, according to an exemplary embodiment of the present invention.

FIGS. 18, 19, 20, and 21 are views showing structural characteristics of a pixel electrode and a common electrode of FIG. 17.

FIGS. 22, 23, and 24 are views showing the structure of a pixel electrode and a common electrode, according to an exemplary embodiment of the present invention.

FIG. 25 is a layout view of a pixel structure of a liquid crystal display, according to another exemplary embodiment of the present invention.

FIG. 26 is a layout view of a pixel structure of a liquid crystal display, according to another exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

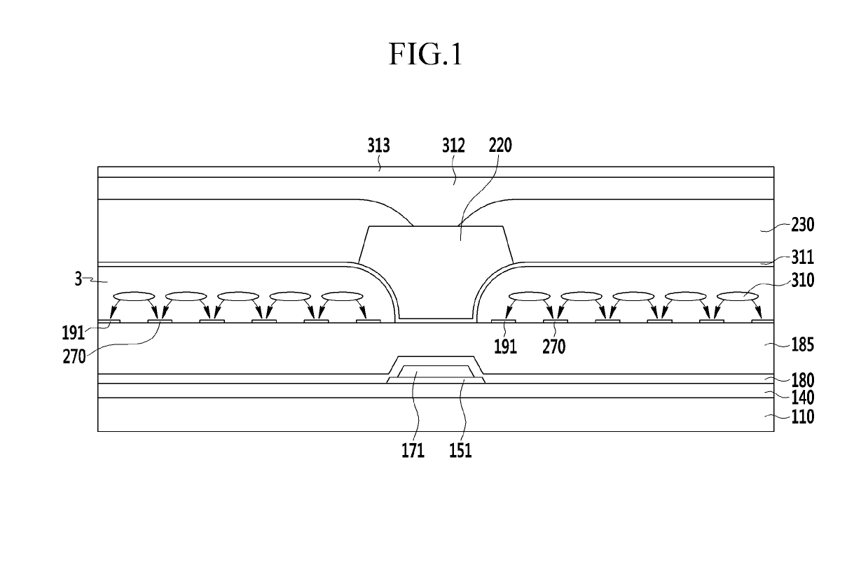

Now, a liquid crystal display according to an exemplary embodiment of the present invention will be described with reference to FIGS. 1 and 17. FIG. 1 is a cross-sectional view of a liquid crystal display according to an exemplary embodiment of the present invention. FIG. 17 is a top plan view of the liquid crystal display of FIG. 1.

Referring to FIGS. 1 and 17, a wiring and a thin film transistor are formed on an is insulation substrate 110 made of transparent glass or plastic, and a pixel electrode 191 and a common electrode 270 are formed thereon. According to an exemplary embodiment, the pixel electrode 191 and the common electrode 270 may be formed from the same layer of material and may have parallel portions. The pixel electrode 191 and the common electrode 270 are positioned in a microcavity. A liquid crystal layer 3 is disposed in the microcavity. The microcavity is supported by overlying layers such as a roof layer 312. A side wall and a top side of the microcavity are contacted with the same layer, such as the lower insulating layer 311.

A gate line 121 (referring to FIG. 17) is formed on the insulation substrate 110. The gate line extends in one direction and includes a gate electrode 124 that protrudes therefrom.

A gate insulating layer 140 is formed on the gate line 121. A semiconductor layer is formed on the gate insulating layer 140. The semiconductor layer may include a semiconductor 151 positioned under the data line 172, a semiconductor positioned under a source/drain electrode, and a semiconductor positioned under a channel portion of a thin film transistor. A plurality of ohmic contacts may be formed between the semiconductor 151, and the data line 172 and the source/drain electrode.

A data conductor including a plurality of data lines 172 including source electrodes 173 and a drain electrode 175 is formed on the semiconductor 151 and the gate insulating layer 140. The gate electrode 124, the source electrode 173, and the drain electrode 175 form a thin film transistor along with the semiconductor of the channel portion.

A first passivation layer 180 is formed on the data conductor and the exposed portion of the semiconductor. The first passivation layer 180 may include an inorganic insulator or an organic insulator, such as silicon nitride (SiNₓ) or silicon oxide (SiOₓ).

A second passivation layer 185 is formed on the first passivation layer 180. The is second passivation layer 185 may include the inorganic insulator such as silicon nitride (SiNₓ) or silicon oxide (SiOₓ), or the organic insulator, thereby providing a flat surface. According to an exemplary embodiment, the first passivation layer 180 and the second passivation layer 185 may be formed into one passivation layer, or one of the two passivation layers may be omitted.

The pixel electrode 191 and the common electrode 270 are formed on the second passivation layer 185. The pixel electrode 191 and the common electrode 270 may be formed of a transparent conductive material, such as ITO or IZO, or a non-transparent conductive material (for example, a metal or an alloy etc.). According to an exemplary embodiment, the pixel electrode 191 and the common electrode 270 may be formed of the same material or of different materials.

The pixel electrode 191 and the common electrode 270 are formed such that they are separated from each other and are not electrically connected to each other, and include portions arranged parallel to each other to form a horizontal electric field. The pixel electrode 191 and the common electrode 270 may be obliquely formed with respect to the gate line 121 and/or the data line 172.

The pixel electrode 191 is electrically connected to the drain electrode 175 through a contact hole formed in the first passivation layer 180 and the second passivation layer 185, to thereby receive a data voltage.

The microcavity is formed on the second passivation layer 185, the pixel electrode 191, and the common electrode 270, and the liquid crystal layer 3 is disposed in the microcavity. The liquid crystal layer 3 has dielectric anisotropy, and liquid crystal molecules 310 of the liquid crystal layer 3 may be arranged such that their long axes are aligned vertically with respect to surfaces of the two panels 100 and 200 when an electric field is not applied.

According to an exemplary embodiment, an alignment layer may be formed in the microcavity. However, an exposure process using ultraviolet rays, to control an initial arrangement direction of the liquid crystal molecules 310, may be omitted.

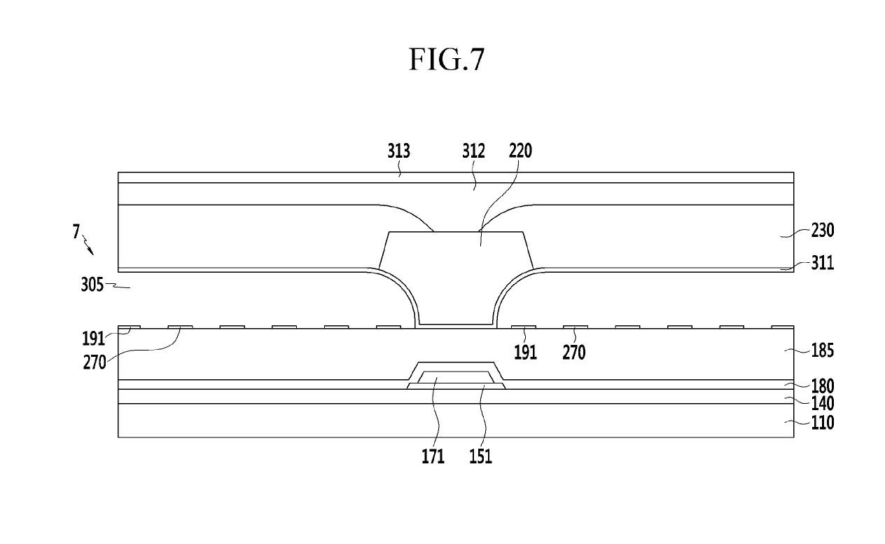

The liquid crystal layer 3 may be injected into a microcavity 305 (referring to FIG. 7) of the microcavity using a capillary force, and the alignment layer may be formed by the capillary force. An alignment direction of the liquid crystal molecules 310 included in the liquid crystal layer 3 is changed according to the electric field formed by the pixel electrode 191 and the common electrode 270.

A lower insulating layer 311 is disposed on the microcavity. A side wall and a top side of the microcavity are contacted with the lower insulating layer 311. The lower insulating layer 311 may include an inorganic insulating material such as silicon nitride (SiNₓ).

A light blocking member 220 (black matrix) is formed on the lower insulating layer 311. The light blocking member 220 is formed in a region where the gate line 121, the thin film transistor, and the data line 172 are formed, and has a lattice structure having openings corresponding to regions where an image is displayed.

Color filters 230 are formed in the openings of the light blocking member 220. The color filters 230 have the same color in the pixels adjacent in a vertical direction (a data line direction). Also, the color filters 230 have different colors in the pixels adjacent in a horizontal direction (a gate line direction). In FIG. 1, two color filters 230 are separated by the light blocking member 220 positioned on the data line 172. However, according to an exemplary embodiment, two color filters 230 may overlap each other. Each color filter 230 may display a primary color, such as red, green, or blue. However, the present invention is not limited thereto, as cyan, magenta, yellow, and white-based colors may also be used.

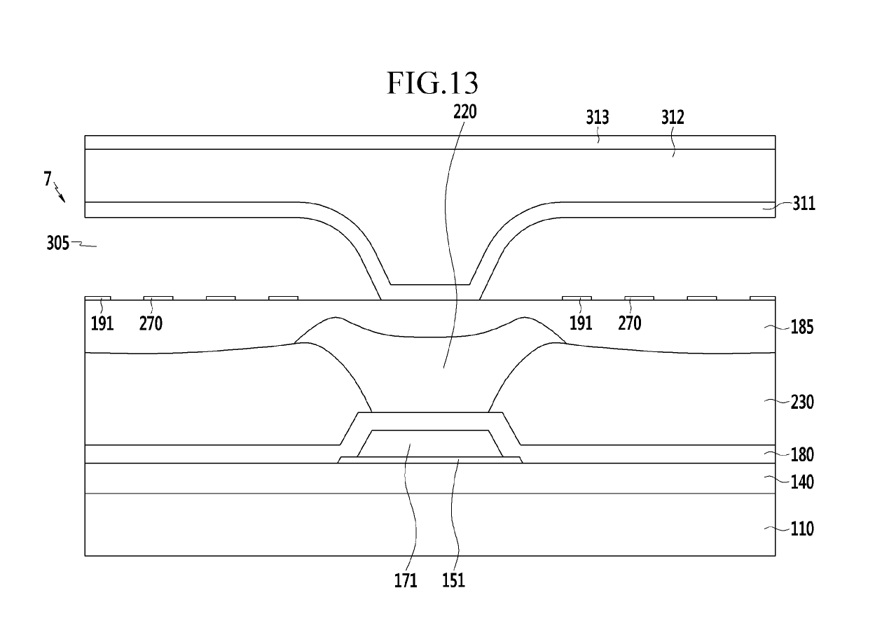

The roof layer 312 is formed on the light blocking member 220 and the color filter 230. The roof layer 312 may at least partially define the microcavity. The roof layer 312, the color filter 230, and the light blocking member 220 may operate together to form the microcavity 305. The microcavity 305 may have a liquid crystal injection hole 7 formed at one side, such that liquid crystal may be injected therein (FIGS. 7 and 13).

An upper insulating layer 313 is formed on the roof layer 312. The upper insulating layer 313 may include the inorganic insulating material such as silicon nitride (SiNₓ). The roof layer 312 and the upper insulating layer 313 may be patterned along with the lower insulating layer 311, the light blocking member 220, and the color filter 230, to form the liquid crystal injection hole 7. The liquid crystal injection hole 7 is used to remove the sacrificial layer 300 used to form the microcavity 305 and is used to inject the liquid crystal layer into at the microcavity 305. Next, the liquid crystal injection hole 7 is sealed.

A polarizer (not shown) is positioned on the lower and upper insulating layers 311 and 313 of the color filter 230. The polarizer includes a polarization element for polarization and a tri-acetyl-cellulose (TAC) layer for durability. Transmissive axes in an upper polarizer and a lower polarizer may be perpendicular or parallel to each other, according various exemplary embodiments.

As described above, the liquid crystal layer 3 is disposed in the microcavity and the pixel electrodes 191 and the common electrode 270 are formed in the microcavity 305 under the liquid crystal layer, such that the liquid crystal molecules 310 are controlled by the horizontal electric field. The common electrode 270 is positioned in the microcavity such that a problem of a height change according to the structure of the microcavity may be eliminated, and the microcavity 305 are not formed on the data lines 172. As such, coupling generated between the is common electrode 270 and the data lines 172 that are close to each other may be reduced.

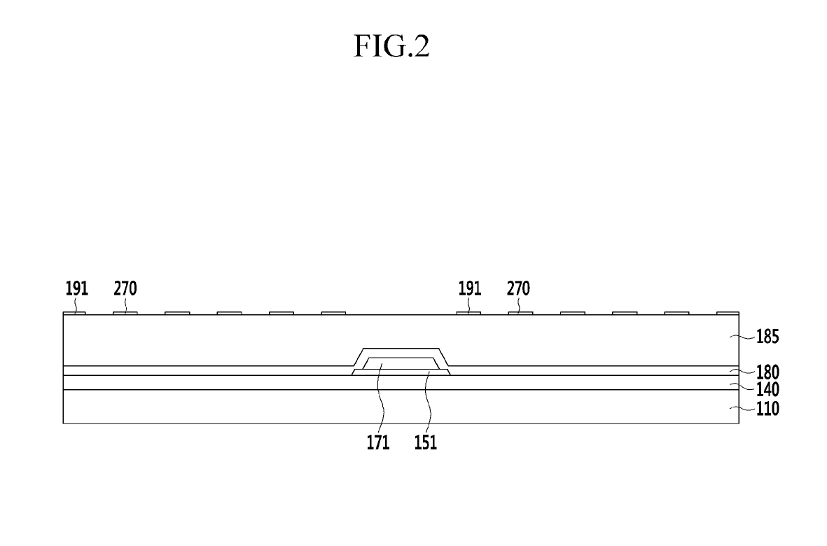

A manufacturing method for the exemplary embodiment of FIG. 1 will be described with reference to FIGS. 2 to 7. FIGS. 2 to 7 are cross-sectional views according to a manufacturing sequence of the liquid crystal display of FIG. 1.

As shown in FIG. 2, a gate line 121 (referring to FIG. 17) is formed on an insulation substrate 110, and a gate insulating layer 140 is deposited thereon. Next, a semiconductor material and a data line metal are deposited and patterned by using a mask (a slit mask or a transflective mask) to form a semiconductor 151, a source electrode, a drain electrode, and a data line 172. The first passivation layer 180 and the second passivation layer 185 are deposited thereon and patterned to form a contact hole 185 (referring to FIG. 17) exposing the drain electrode. Next, a conductive material is deposited and etched on the second passivation layer 185 to form the pixel electrode 191 and the common electrode 270. Here, the pixel electrode is connected to the drain electrode through the contact hole.

In FIG. 2, each step of forming the wiring, the thin film transistor, the pixel electrode, and the common electrode is omitted and is shown through one drawing. Various exemplary embodiments of this structure may be provided.

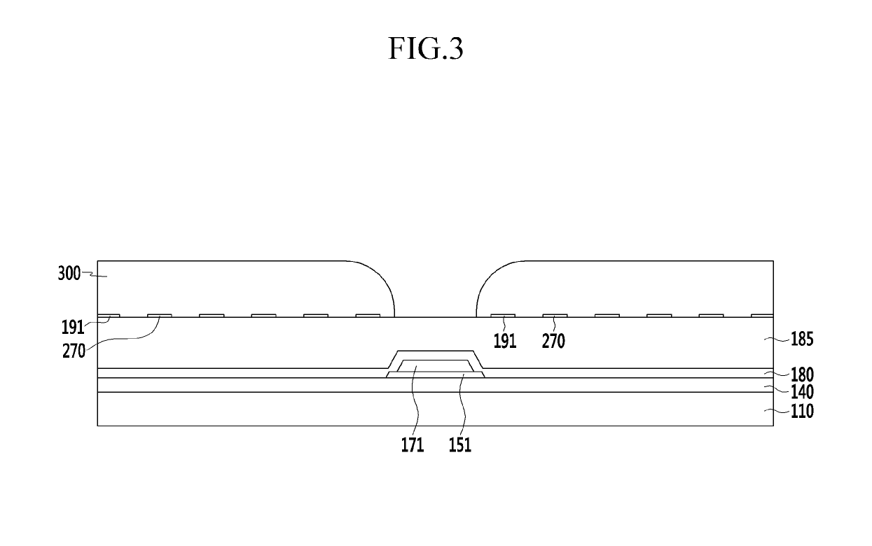

Next, as shown in FIG. 3, the sacrificial layer 300 is formed by using a photoresist material PR. That is, the photoresist PR material is deposited then exposed and developed to form the sacrificial layer 300. The sacrificial layer 300 is removed later, thereby forming a region where the microcavity will be formed.

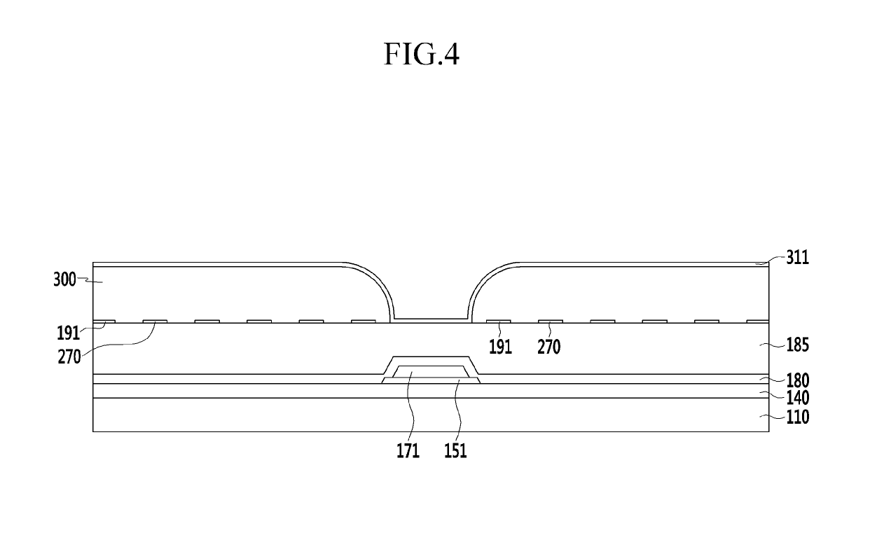

Next, as shown in FIG. 4, the inorganic insulating material is deposited on the sacrificial layer 300 and the second passivation layer 185, to form the lower insulating layer 311. The lower insulating layer 311 may be formed throughout the entire region. A side wall and a is top side of the sacrificial layer 300 are contacted with the lower insulating layer 311

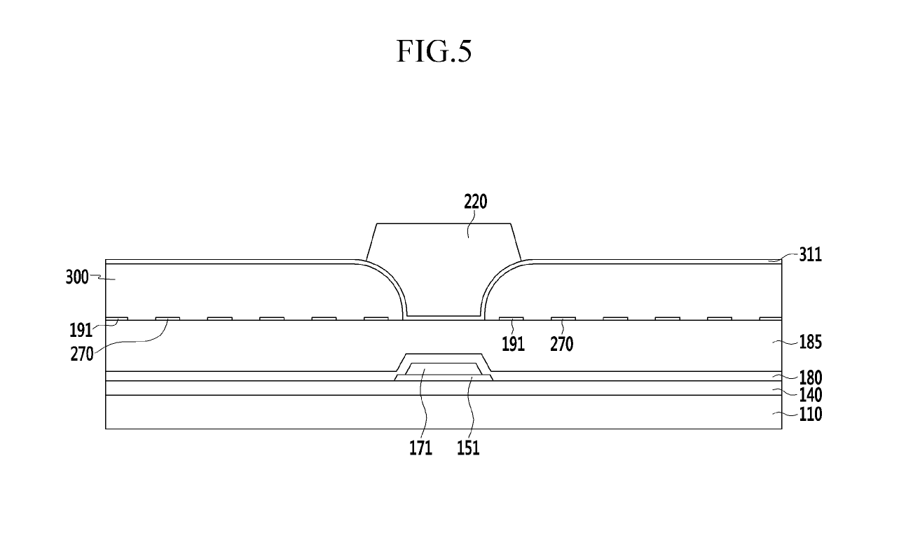

Next, as shown FIG. 5, the light blocking member 220 is formed on the lower insulating layer 311. The light blocking member 220 may be formed of a material through which light is not transmitted, for example, an organic material, a metal, or a black pigment. The light is transmitted through the openings of the blocking member 220 to form an image.

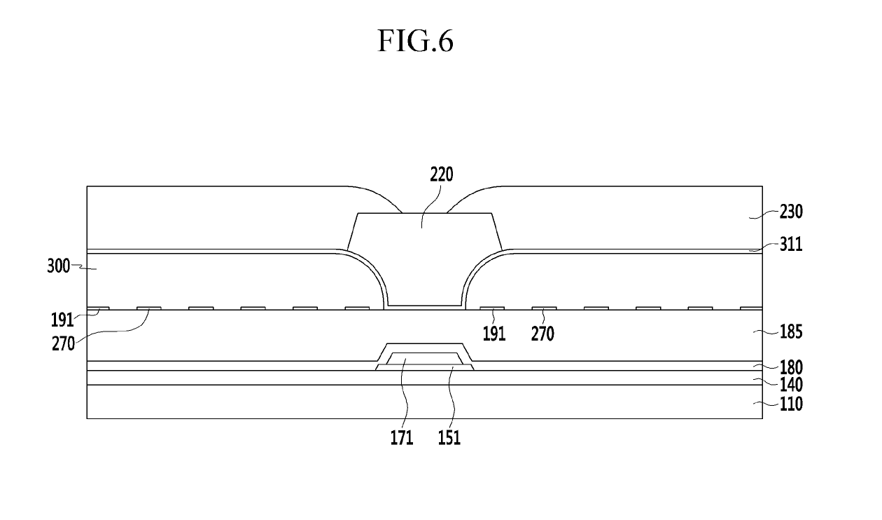

Next, as shown in FIG. 6, color filters 230 are formed on the lower insulating layer 311 and the light blocking member 220. Color filters 230 of pixels adjacent in the vertical direction (the data line direction) have the same color. Also, color filters 230 of pixels adjacent in the horizontal direction (the gate line direction) have different colors.

Next, as shown in FIG. 7, the upper insulating layer 313 is formed on the roof layer 312. The roof layer 312 may not be formed at a position where the liquid crystal injection hole 7 will be formed, such that when the sacrificial layer is removed the liquid crystal can be injected. Next, the upper insulating layer 313 is deposited on the entire region. Portions of the roof layer 312 are removed such that the upper insulating layer 313 may directly contact the color filters 230 and/or the light blocking member 220.

Next, the upper insulating layer 313, the color filter 230 or the light blocking member 220, and the lower insulating layer 311 are etched to form the liquid crystal injection hole 7 such that the sacrificial layer 300 is exposed. While not shown, injection holes may be formed in multiple microcavities 305. At this time, the photoresist PR is formed on the upper insulating layer 313, such that the sacrificial layer 300 is only exposed at the liquid crystal injection hole 7.

Next, the exposed sacrificial layer 300 is removed by a wet etching or dry etching to form a microcavity 305. The microcavity 305 may or may not be in fluid communication with one another.

Next, as shown in FIG. 1, liquid crystal molecules 310 are injected into the microcavity by the capillary force to form the liquid crystal layer 3. A polarizer (not shown) is attached to the lower upper insulating layer 313.

In the above manufacturing method, the pixel electrode 191 and the common electrode 270 are formed by using one mask, such that a separate process in not required for forming the common electrode 270.

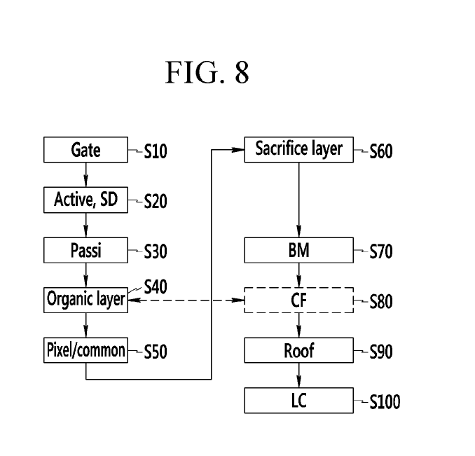

The manufacturing method may be summarized through a flowchart as shown in FIG. 8. FIG. 8 is a flowchart of a manufacturing method of a liquid crystal display according to an exemplary embodiment of the present invention.

After a gate line including a gate electrode is formed on an insulation substrate 110 (S 10), a gate insulating layer 140 is deposited. Next, a semiconductor material and a data line material are sequentially deposited and etched by using a mask, to form a semiconductor 151, source/drain electrodes, and a data line 172 (S20).

The first passivation layer 180 (in FIG. 8, indicated by Passi) is deposited (S30), and the second passivation layer 185 (in FIG. 8, indicated by Organic layer) is deposited (S40). The first passivation layer 180 and the second passivation layer 185 are etched to form a contact hole exposing the drain electrode. Then a pixel electrode 191 and a common electrode 270 are formed (S50).

The sacrificial layer 300 is formed (S60), a light blocking member 220 is formed thereon (S70), and then a color filter 230 is formed thereon (S80). In FIG. 8, the step (S40) of forming the second passivation layer 185 (in FIG. 8, indicated by Organic layer) and the step (S80) of forming the color filter 230 are connected by a dotted line, which means that positions is of the two steps may be exchanged according to various exemplary embodiments.

Next, the roof layer 312 is formed (S90), a liquid crystal injection hole 7 is formed, and then the sacrificial layer 300 is removed through the liquid crystal injection hole 7 to form a microcavity. A liquid crystal is injected into the microcavity (S 100).

In FIG. 8, the flowchart focuses only on the main steps, and may be used to produce a structure different from the structure of FIG. 1. As shown in FIG. 8, the pixel electrode 191 and the common electrode 270 are formed through one step (S50), such that a separate process is not needed to form the common electrode 270.

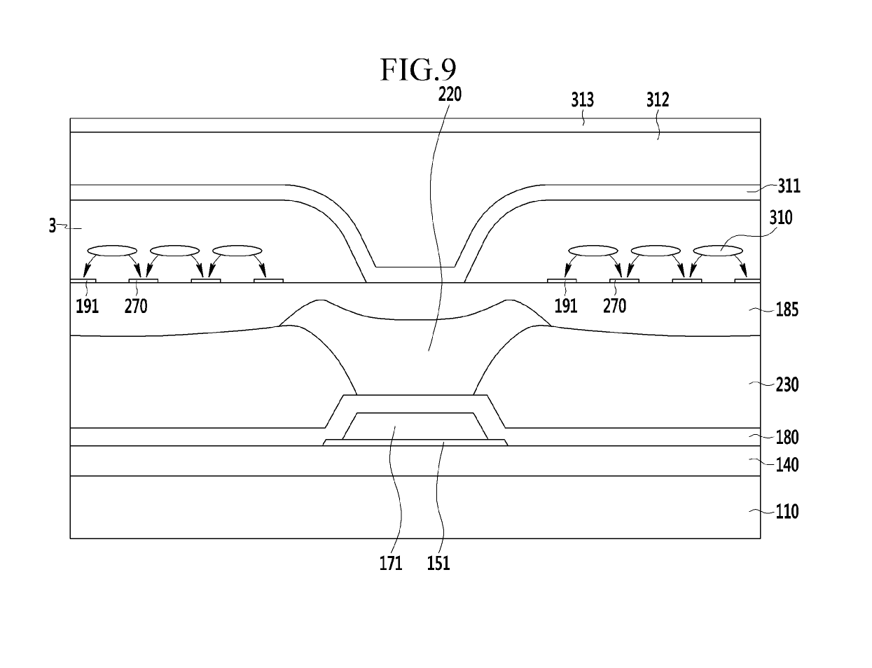

Another exemplary embodiment of the present invention will be described with reference to FIGS. 9 to 14. Firstly, the entire structure will described with reference to FIG. 9. FIG. 9 is a cross-sectional view of a liquid crystal display according to another exemplary embodiment of the present invention.

In FIG. 9 differs from FIG. 1, in that the light blocking member 220 and the color filter 230 are positioned under the pixel electrode 191 and the common electrode 270, such that the liquid crystal layer 3 is disposed on the light blocking member 220 and the color filter 230. Also, like FIG. 1, the pixel electrode 191 and the common electrode 270 are formed from the same layer of material and may have portions that extend parallel to each other.

Next, a structure of a liquid crystal display, according to an exemplary embodiment of the present invention, will be described with regard to FIG. 17. Referring to FIG. 17, a gate line 121 is formed on an insulation substrate 110 made of transparent glass or plastic. The gate line 121 extends in one direction and includes a gate electrode 124 protruding therefrom.

A gate insulating layer 140 is formed on the gate line 121. A semiconductor layer is formed on the gate insulating layer 140. The semiconductor layer may include a semiconductor 151 positioned under the data line 172, a semiconductor positioned under the source/drain electrode, and a semiconductor positioned under the channel portion of the thin film transistor. Ohmic contacts are formed between the semiconductor 151 and data line 172, and the source/drain electrode.

A data conductor including a plurality of data lines 172 including a source electrode 173 and a plurality of drain electrodes 175 are formed on the semiconductor 151 and the gate insulating layer 140. The gate electrode 124, the source electrode 173, and the drain electrode 175 form the thin film transistor along with the semiconductor including the channel portion.

The first passivation layer 180 is formed on the data conductor and the exposed semiconductor. The first passivation layer 180 may include the inorganic insulator, such as silicon nitride (SiNₓ) or silicon oxide (SiOₓ), or the organic insulator.

Color filters 230 are formed on the first passivation layer 180. Color filters 230 of the same color are formed in the pixels adjacent to each other in the vertical direction (the data line direction). Color filters 230 of different colors are formed in the pixels adjacent to each other in the horizontal direction. In FIG. 9, two color filters 230 are separated with a predetermined interval on the data line 172 (FIG. 17).

A light blocking member 220 (black matrix) is formed on the color filters 230. The light blocking member 220 is formed with reference to a region where the gate line 121, the thin film transistor, and the data line 172 are formed, and has a lattice structure having openings corresponding to a region where an image is displayed. The color filters 230 are positioned at the openings of the light blocking member 220.

The second passivation layer 185 is formed on the light blocking member 220. The second passivation layer 185 may include the organic insulator, and in the exemplary embodiment in FIG. 9, the second passivation layer 185 is used to reduce a step height and to provide the flat surface. According to various embodiments, at least one of the first passivation layer 180 and the second passivation layer 185 may be omitted.

The pixel electrode 191 and the common electrode 270 are formed on the second passivation layer 185. The pixel electrode 191 and the common electrode 270 may be formed of a transparent conductive material, such as ITO or IZO, or a non-transparent conductive material (for example, a metal or an alloy etc.). According to various embodiments, the pixel electrode 191 and the common electrode 270 may be formed with the same material, or with different materials.

The pixel electrode 191 and the common electrode 270 are formed on the same layer (in the same plane), such that they are separated from each other and are not electrically connected to each other. The pixel electrode 191 and the common electrode 270 include portions arranged in parallel to each other to form a horizontal electric field. The pixel electrode 191 and the common electrode 270 may be obliquely formed with respect to the gate line 121 or the data line 172.

The pixel electrode 191 is electrically connected to the drain electrode 175 through a contact hole formed in the first passivation layer 180, light blocking member 220, the color filter 230, and the second passivation layer 185. The microcavity is formed on the second passivation layer 185, the pixel electrode 191, and the common electrode 270, and the liquid crystal layer 3 is formed in the microcavity 305.

According to an exemplary embodiment, an alignment layer may be formed in the microcavity 305. However, to control an initial arrangement direction of the liquid crystal molecules 310, an exposure process using ultraviolet rays may be omitted.

The liquid crystal layer 3 may be injected in the microcavity 305 (referring to FIG. 13) by using a capillary force. The alignment layer may be formed by the capillary force. By the electric field formed by the pixel electrode 191 and the common electrode 270, an alignment direction of the liquid crystal molecules 310 included in the liquid crystal layer 3 is controlled.

A lower insulating layer 311 is positioned on the microcavity. The lower insulating layer 311 may include an inorganic insulating material such as silicon nitride (SiNₓ). A roof layer 312 is formed on the lower insulating layer 311. The roof layer 312 may have a supporting function to facilitate the formation of the microcavity.

An upper insulating layer 313 is formed on the roof layer 312. The upper insulating layer 313 may include the inorganic insulating material such as silicon nitride (SiNₓ). The roof layer 312 and the upper insulating layer 313 may be patterned along with the lower insulating layer 311, the light blocking member 220, and the color filter 230, to form the liquid crystal injection hole(s) 7. The liquid crystal injection hole 7 is used to remove the sacrificial layer 300 to form the microcavity and to inject the liquid crystal layer. Next, the liquid crystal injection hole 7 is sealed.

A polarizer (not shown) is positioned on the lower and upper insulating layers 311 and 313 of the insulation substrate 110. The polarizer includes a polarization element and a tri-acetyl-cellulose (TAC) layer for ensuring durability. Transmissive axes in an upper polarizer and a lower polarizer may be perpendicular or parallel to each other.

As described above, in the liquid crystal display, the liquid crystal layer 3 is is formed in the microcavity. The pixel electrode 191 and the common electrode 270 are formed on the same layer (plane) under the liquid crystal layer 3, such that the liquid crystal molecules 310 are arranged by the horizontal electric field. The common electrode 270 is positioned on the microcavity, such that a problem of a height change according to the structure of the microcavity may be eliminated. The microcavity 305 is not formed on the data line 172, such that coupling generated between the common electrode 270 and the data line 172 may be reduced.

Also, in the exemplary embodiment of FIG. 9, differently from the exemplary embodiment of FIG. 1, the color filters 230 are formed under the sacrificial layer 300 and the microcavity 305, such that the color filters 230 are formed first in the process. When the color filters 230 include the organic material, a bake process may be performed. However, the bake process may harden the sacrificial layer 300, such that it may be difficult to etch the sacrificial layer 300. However, in the exemplary embodiment of FIG. 9, the sacrificial layer 300 is formed after forming the color filter 230, such that the sacrificial layer 300 is not hardened and may be easily removed by wet etching.

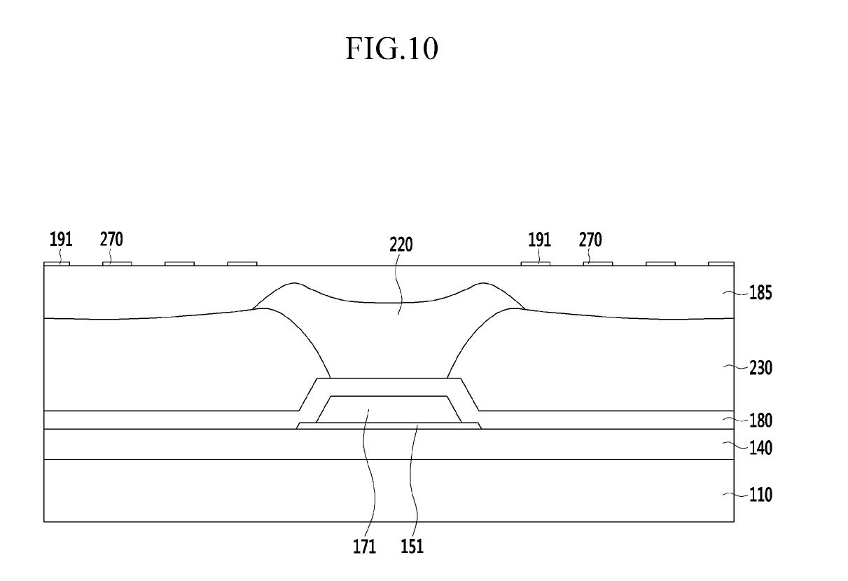

FIGS. 10 to 13 are cross-sectional views illustrating a manufacturing sequence of the liquid crystal display of FIG. 9.

As shown in FIG. 2, a gate line (referring to 121 of FIG. 17) is formed on an insulation substrate 110 made of transparent glass or plastic, and a gate insulating layer 140 is deposited thereon. Next, a semiconductor material and a data line metal are deposited and patterned by using a mask (a slit mask or a transflective mask) to form a semiconductor 151, a source electrode, a drain electrode, and a data line 172. Next, the first passivation layer 180 is formed thereon, and then the color filters 230 are formed. Color filters 230 of the same color are formed in the pixels adjacent in the vertical direction (the data line direction). Also, color filters 230 of different colors are formed in the pixels adjacent in the horizontal direction (the data line direction). The light blocking member 220 is formed on the color filter 230. The color filters 230 are positioned in openings of the light blocking member 220. The light blocking member 220 may be formed of a material through which light is not transmitted, for example, an organic material such as a metal or a black pigment. The light is transmitted through the openings of the blocking member 220. Next, the second passivation layer 185 is formed on the color filter 230 and the light blocking member 220. Then, the first passivation layer 180, the color filters 230 or the light blocking member 220, and the second passivation layer are patterned to form the contact hole 185 (referring to FIG. 17) exposing the drain electrode. Next, the conductive material is deposited and etched to form the pixel electrode 191 and the common electrode 270 on the second passivation layer 185. Here, the pixel electrode is connected to the drain electrode through the contact hole.

In FIG. 10, the steps of forming the wiring, the thin film transistor, the light blocking member, the color filter, the pixel electrode, and the common electrode are shown through one drawing. This structure may be realized by various exemplary embodiments.

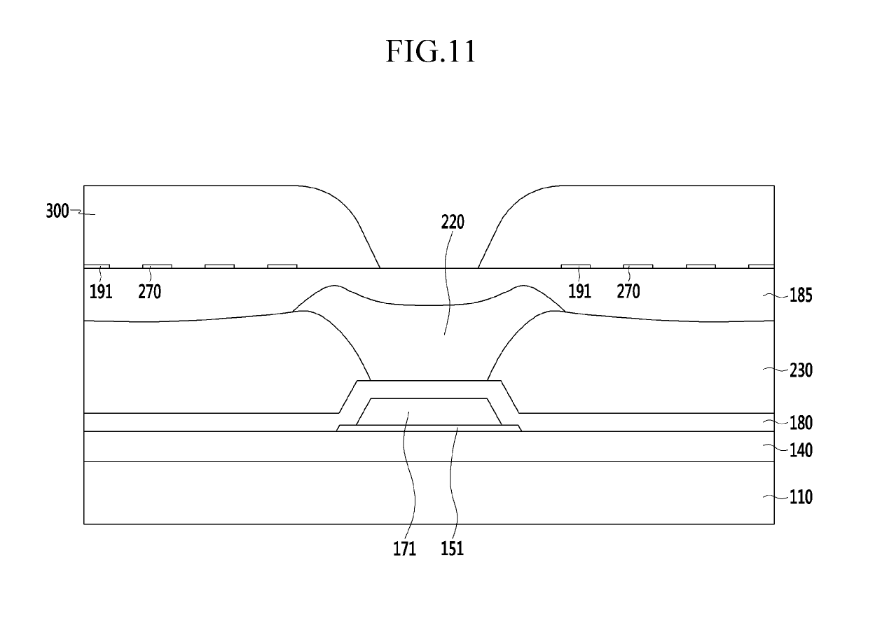

As shown in FIG. 11, the sacrificial layer 300 is formed by using a photoresist material PR. That is, the photoresist material PR is deposited, exposed, and developed to form the sacrificial layer 300. The sacrificial layer 300 is later removed, thereby forming regions where the microcavity will be formed.

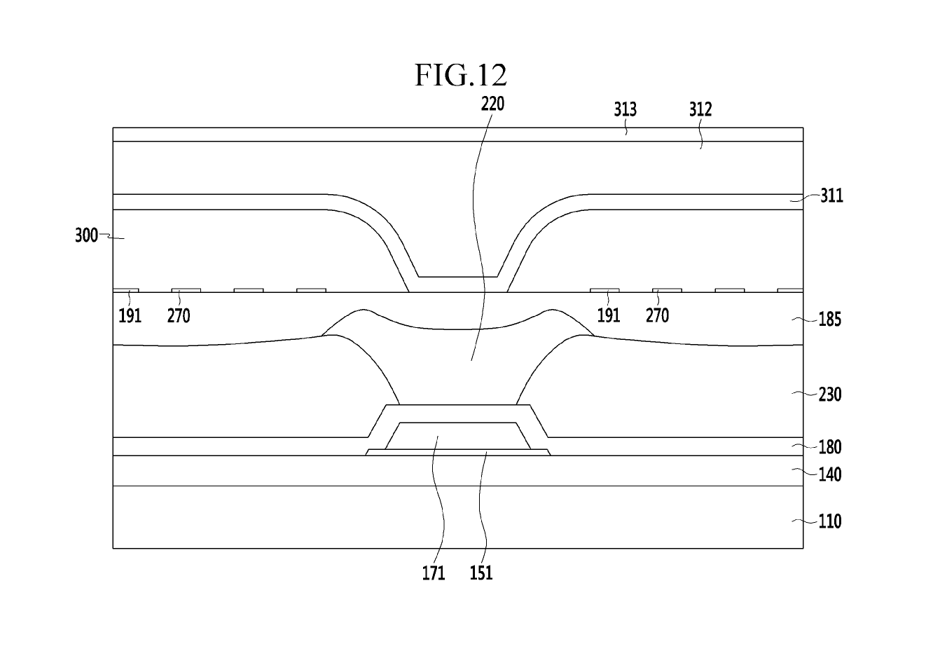

As shown in FIG. 12, the lower insulating layer 311, the roof layer 312, and the upper insulating layer 313 are sequentially formed on the sacrificial layer 300 and the second passivation layer 185. The lower insulating layer 311 and the upper insulating layer 313 are formed of the inorganic insulating material such as silicon nitride (SiNₓ), and the roof layer 312 is formed of the organic material. The roof layer 312 may not be formed at a position where the liquid crystal injection hole 7 will be formed. As a result, the lower insulating layer 311 and the upper insulating layer 313 may directly contact one another.

The upper insulating layer 313 and the lower insulating layer 311 of the region where the roof layer 312 is not formed are removed to form the liquid crystal injection hole(s) 7, thereby exposing the sacrificial layer 300. At this time, the photoresist material PR is formed on the upper insulating layer 313, such that the sacrificial layer 300 is only exposed at the liquid crystal injection hole 7.

Next, as shown in FIG. 13, the exposed sacrificial layer 300 is removed by wet etching or dry etching, to form microcavity 305. Here, the sacrificial layer 300 may be removed by the wet etching, and the photoresist material PR may be removed to form the liquid crystal injection hole 7. Since the color filters 230 and the light blocking member 220 are formed before the sacrificial layer 300, the sacrificial layer 300 does not undergo the bake process, which facilitates the wet etching thereof. Also, the sacrificial layer 300 is formed of the photoresist material PR, such that the photoresist material PR positioned on the upper insulating layer 313 is removed through the wet etching.

As shown in FIG. 9, liquid crystal molecules 310 are injected into the microcavity 305 by the capillary force, to form the liquid crystal layer 3. Next, a polarizer (not shown) is attached to the lower upper insulating layer 313.

In the above manufacturing method, the pixel electrode 191 and the common electrode 270 are formed by using one mask, such that the common electrode 270 can be formed without a separate process. Also, the sacrificial layer 300 may be easily removed by the wet etching, and the sacrificial layer 300 is formed of the photoresist material PR, such that the photoresist material PR may also be removed through the wet etching, thereby reducing the number of processes.

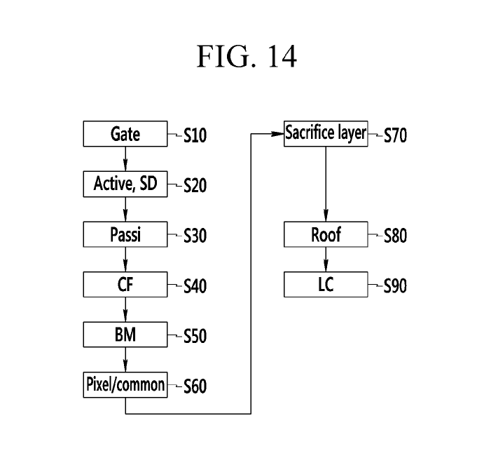

FIG. 14 is a flowchart of a manufacturing method of a liquid crystal display according to an exemplary embodiment of the present invention. Referring to FIG. 14, after a gate line including a gate electrode is formed on an insulation substrate 110 (S 10), a gate insulating layer 140 is deposited. Next, a semiconductor material and a data line material are sequentially deposited and etched by using a mask, to form a semiconductor 151, a source/drain electrode, and a data line 172 (S20).

Next, the first passivation layer 180 (in FIG. 14, indicated by Passi) is deposited (S30), and the color filter 230 is formed thereon (S40). Next, the light blocking member 220 having the openings corresponding to the color filters 230 are formed S50.

After forming the second passivation layer 185 and the light blocking member 220, the first passivation layer 180, the color filter 230, the light blocking member 220, and the second passivation layer 185 are etched to form the contact hole exposing the drain electrode. Then the pixel electrode 191 and the common electrode 270 are formed (S60).

The sacrificial layer 300 is formed (S70), and then the roof layer 312 is formed thereon (S80). Then the liquid crystal injection hole 7 is formed, and the sacrificial layer 300 is removed through the liquid crystal injection hole 7 to form the microcavity. The sacrificial layer 300 may be removed by the wet etching. When the sacrificial layer 300 is formed of the photoresist material PR, the photoresist PR used to form the liquid crystal injection hole may be removed by the wet etching. Next, a liquid crystal is injected into the microcavity (S90).

As shown in FIG. 14, the pixel electrode 191 and the common electrode 270 are formed through one step (S50). Also, the sacrificial layer 300 is wet-etched along with the photoresist PR. As such, the number of processes is reduced.

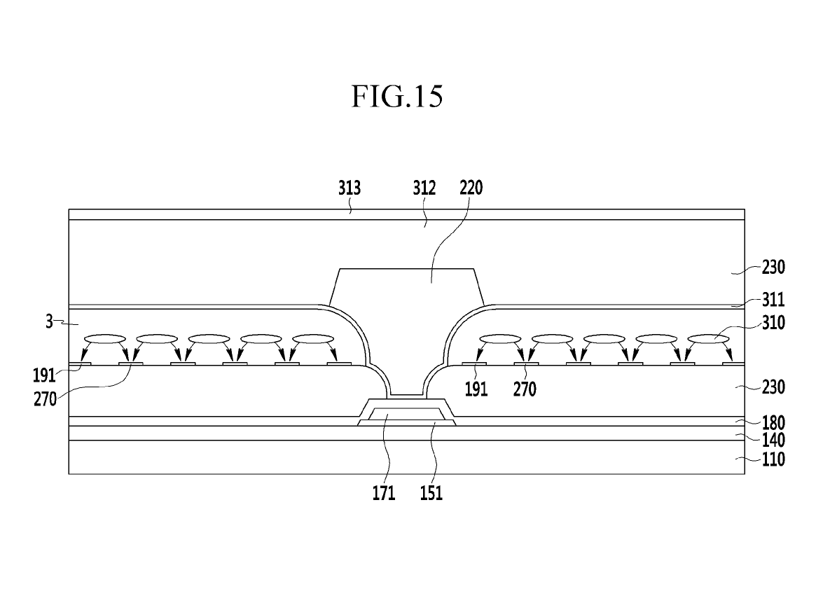

FIG. 15 is a cross-sectional view of a liquid crystal display according to another exemplary embodiment of the present invention. Unlike the exemplary embodiment of FIG. 1, in the exemplary embodiment of FIG. 15, the color filters 230 are positioned under the pixel electrode 191 and the common electrode 270, and the liquid crystal layer 3 is positioned on the color filters 230. Also, like FIG. 1 and FIG. 9, the pixel electrode 191 and the common electrode 270 are formed with on same layer and may be formed of the same material and may have the parallel portions.

Next, a structure of the liquid crystal display according to an exemplary embodiment of the present invention will be described. A gate line 121 (referring to FIG. 17) is formed on an insulation substrate 110 made of transparent glass or plastic. The gate line extends in one direction and includes a gate electrode 124 (referring to FIG. 17).

A gate insulating layer 140 is formed on the gate line 121. A semiconductor layer is formed on the gate insulating layer 140. The semiconductor layer may include a semiconductor 151 positioned under the data line 172, a semiconductor positioned under a source/drain electrode, and a semiconductor positioned under a channel portion of a thin film transistor. A plurality of ohmic contacts may be formed between the semiconductor 151, and the data line 172 and the source/drain electrode.

A data conductor including a plurality of data lines 172 including source electrodes 173 (referring to FIG. 17) and a drain electrode 175 (referring to FIG. 17) is formed on the semiconductor 151 and the gate insulating layer 140.

The gate electrode 124, the source electrode 173, and the drain electrode 175 form a thin film transistor along with the semiconductor of the channel portion. The first passivation is layer 180 is formed on the data conductor and the exposed portion of the semiconductor. The first passivation layer 180 may include an inorganic insulator or an organic insulator, such as silicon nitride (SiNₓ) or silicon oxide (SiOₓ).

Color filters 230 are formed on the first passivation layer 180. Color filters 230 of the same color are formed in the pixels adjacent into a vertical direction (a data line direction). Also, color filters 230 of different colors are formed in the pixels adjacent in a horizontal direction (a gate line direction). In FIG. 15, two color filters 230 are separated by a portion of the light blocking member 220 positioned on the data line 172. However, according to an exemplary embodiment, two color filters 230 may overlap each other.

A pixel electrode 191 and a common electrode 270 are formed on the color filters 230. The pixel electrode 191 and the common electrode 270 may be formed of a transparent conductive material, such as ITO or IZO, or a non-transparent conductive material (for example, a metal or an alloy etc.). According to various embodiments, the pixel electrode 191 and the common electrode 270 may be formed with the same material or of different materials.

The pixel electrode 191 and the common electrode 270 are formed from the same layer of material, such that they are separated from each other and not electrically connected to each other. The pixel electrode 191 and the common electrode 270 include portions arranged in parallel to each other to form a horizontal electric field. The pixel electrode 191 and the common electrode 270 may be obliquely formed with respect to the gate line 121 or the data line 172.

The pixel electrode 191 is electrically connected to the drain electrode 175 through a contact hole formed in the first passivation layer 180 and the color filter 230, thereby receiving a data voltage. A microcavity is formed on the first passivation layer 180, the color is filter 230, the pixel electrode 191 and the common electrode 270. A liquid crystal layer 3 is formed in the microcavity.

According to an exemplary embodiment, an alignment layer may be formed at the microcavity. However, an exposure process using ultraviolet rays may be omitted.

The liquid crystal layer 3 be injected into the microcavity 305 (referring to FIG. 7) by using a capillary force, and the alignment layer may be formed by the capillary force. By the electric field formed by the pixel electrode 191 and the common electrode 270, an alignment direction of the liquid crystal molecule 310 included in the liquid crystal layer 3 is controlled.

A lower insulating layer 311 is positioned on the microcavity, the color filter 230, and the first passivation layer 180. The lower insulating layer 311 may include the inorganic insulating material such as silicon nitride (SiNₓ).

A light blocking member 220 (black matrix) is formed on the lower insulating layer 311. The light blocking member 220 is formed with respect to a region where the gate line 121, the thin film transistor, and the data line 172 are formed, and has a lattice structure having openings corresponding to a region where an image is displayed. The color filters 230 are disposed in the openings of the light blocking member 220.

A roof layer 312 is formed on the light blocking member 220 and the lower insulating layer 311. The roof layer 312 may support the upper surface of the microcavity.

An upper insulating layer 313 is formed on the roof layer 312. The upper insulating layer 313 may include the inorganic insulating material. The roof layer 312 and the upper insulating layer 313 may be patterned along with the lower insulating layer 311 to form the liquid crystal injection hole 7. The liquid crystal injection hole lis used to remove the sacrificial layer 300 to form the microcavity and to inject the liquid crystal layer in the microcavity. Next, is the liquid crystal injection hole 7 is sealed.

A polarizer (not shown) is positioned on the lower and the upper insulating layer 313 of the insulation substrate 110. The polarizer is as described above.

As described above, the liquid crystal layer 3 is formed in the microcavity, and the pixel electrode 191 and the common electrode 270 are formed on the same layer under the liquid crystal layer, such that the liquid crystal molecules 310 are arranged by the horizontal electric field. The common electrode 270 is positioned in the microcavity such that a problem of a height change according to the structure of the microcavity may be eliminated. The microcavity 305 is not formed on the data lines 172.

In contrast to the embodiment of FIG. 1, in FIG. 15 the color filters 230 are formed under the sacrificial layer 300 and the microcavity 305, such that the sacrificial layer 300 is not hardened by a baking process. Also, in the exemplary embodiment of FIG. 15, the photoresist material PR used when forming the liquid crystal injection hole 7 may be wet-etched along with the sacrificial layer 300.

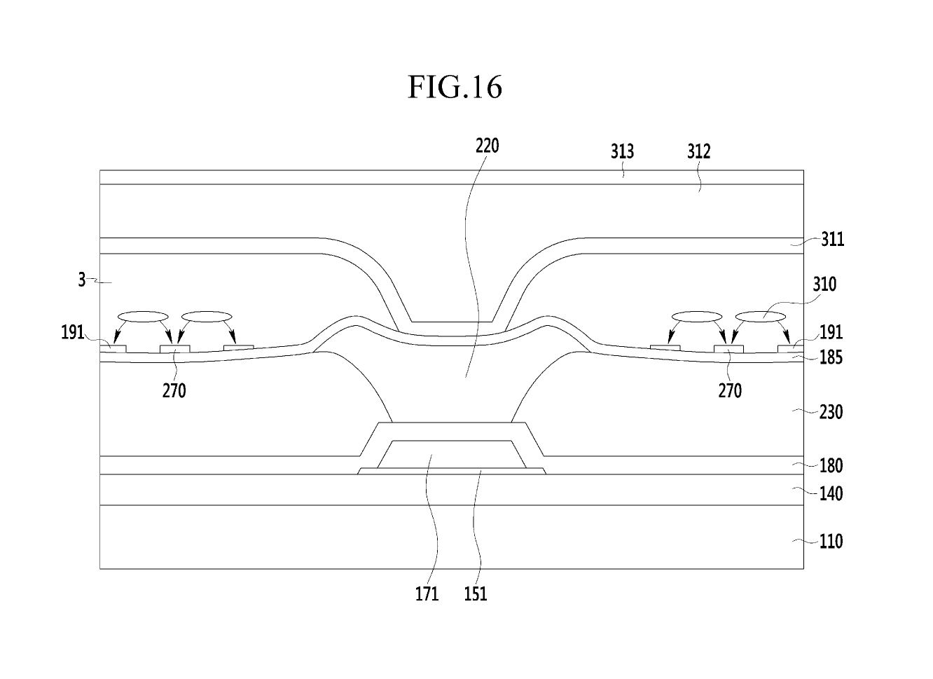

FIG. 16 is a cross-sectional view of a liquid crystal display according to another exemplary embodiment of the present invention. The exemplary embodiment of FIG. 16 is similar to the exemplary embodiment of FIG. 9. However, the second passivation layer 185 is formed of the inorganic insulating material. That is, when forming the second passivation layer 185 in the exemplary embodiment of FIG. 9, the flatness may be improved by the second passivation layer 185. However, this improvement may not be realized in the exemplary embodiment of FIG. 16.

In contrast to the exemplary embodiment of FIG. 1, in the exemplary embodiment of FIG. 16, the light blocking member 220 and the color filters 230 are positioned under the pixel is electrode 191 and the common electrode 270. The liquid crystal layer 3 is disposed in the microcavity and on the light blocking member 220 and the color filters 230. Also, like FIG. 1, the pixel electrode 191 and the common electrode 270 are formed on the same layer, and they may be formed of the same type of material and may have portions that extend parallel to each other.

FIG. 17 illustrates the structure of the liquid crystal display, according to an exemplary embodiment of the present invention. Referring to FIG. 17, a gate line 121 is formed on an insulation substrate 110 made of transparent glass or plastic. The gate line 121 extends in one direction and includes a gate electrode 124.

A gate insulating layer 140 is formed on the gate line 121. A semiconductor layer is formed on the gate insulating layer 140. The semiconductor layer includes a semiconductor 151 positioned under the data line 172, a semiconductor positioned under the source/drain electrode, and a semiconductor positioned under the channel portion of the thin film transistor. Ohmic contacts are formed between the semiconductor 151 and the data line 172 and the source/drain electrode.

A data conductor including a plurality of data lines 172 including a source electrode 173 and a plurality of drain electrodes 175 are formed on the semiconductor 151 and the gate insulating layer 140. The gate electrode 124, the source electrode 173, and the drain electrode 175 form the thin film transistor along with the semiconductor including the channel portion.

The first passivation layer 180 is formed on the data conductor and the exposed semiconductor. The first passivation layer 180 may include the inorganic insulator such as silicon nitride (SiNₓ) or silicon oxide (SiOₓ), or the organic insulator.

Color filters 230 are formed on the first passivation layer 180. Color filters 230 of the same color are formed in the pixels adjacent to each other in the vertical direction (the data line direction). Color filters 230 of different colors are formed in the pixels adjacent to each other in the horizontal direction. In FIG. 9, two color filters 230 are separated by a predetermined interval on the data line 172 (FIG. 17).

A light blocking member 220 (black matrix) is formed on the color filters 230. The light blocking member 220 is formed with reference to a region where the gate line 121, the thin film transistor, and the data line 172 are formed, and has a lattice structure having openings corresponding to a region where an image is displayed. The color filters 230 are positioned at the openings of the light blocking member 220.

The second passivation layer 185 is formed on the light blocking member 220. The second passivation layer 185 may include the inorganic insulator such as silicon nitride (SiNₓ) and silicon oxide (SiOₓ). In the exemplary embodiment of FIG. 16, the inorganic insulator is used such that the flatness characteristic is not realized. According to an exemplary embodiment, at least one of the first passivation layer 180 and the second passivation layer 185 may be omitted.

The pixel electrode 191 and the common electrode 270 are formed on the second passivation layer 185. The pixel electrode 191 and the common electrode 270 may be formed of a transparent conductive material, such as ITO or IZO, or a non-transparent conductive material (for example, a metal or an alloy etc.). According to various embodiments, the pixel electrode 191 and the common electrode 270 may be formed with the same material, or with different materials.

The pixel electrode 191 and the common electrode 270 are formed on the same is layer (in the same plane), such that they are separated from each other and are not electrically connected to each other. The pixel electrode 191 and the common electrode 270 include portions arranged in parallel to each other to form a horizontal electric field. The pixel electrode 191 and the common electrode 270 may be obliquely formed with respect to the gate line 121 or the data line 172.

The pixel electrode 191 is electrically connected to the drain electrode 175 through the contact hole formed in the first passivation layer 180, the light blocking member 220, the color filter 230, and the second passivation layer 185. The microcavity is formed on the second passivation layer 185, the pixel electrode 191, and the common electrode 270, and the liquid crystal layer 3 is formed in the microcavities 305 of the microcavity.

According to an exemplary embodiment, an alignment layer may be formed at the microcavity 305. However, to control an initial arrangement direction of the liquid crystal molecules 310, an exposure process using ultraviolet rays may be omitted.

The liquid crystal layer 3 may be injected into the microcavity 305 (referring to FIG. 13) by using a capillary force. The alignment layer may be formed by the capillary force. By the electric field formed by the pixel electrode 191 and the common electrode 270, an alignment direction of the liquid crystal molecules 310 included in the liquid crystal layer 3 is controlled.

A lower insulating layer 311 is positioned on the microcavity. The lower insulating layer 311 may include an inorganic insulating material such as silicon nitride (SiNₓ). A roof layer 312 is formed on the lower insulating layer 311. The roof layer 312 may have a supporting function to facilitate the formation of the microcavity.

An upper insulating layer 313 is formed on the roof layer 312. The upper is insulating layer 313 may include the inorganic insulating material such as silicon nitride (SiNₓ). The roof layer 312 and the upper insulating layer 313 may be patterned along with the lower insulating layer 311 to form the liquid crystal injection hole(s) 7. The liquid crystal injection hole 7 is used to remove the sacrificial layer 300 to form the microcavity 305 and to inject the liquid crystal layer at the microcavity. Next, the liquid crystal injection hole 7 is sealed.

A polarizer (not shown) is positioned on the lower and upper insulating layers 311 and 313 of the insulation substrate 110. The polarizer includes a polarization element and a tri-acetyl-cellulose (TAC) layer for ensuring durability. Transmissive axes in an upper polarizer and a lower polarizer may be perpendicular or parallel to each other.

As described above, in the liquid crystal display, the liquid crystal layer 3 is formed in the microcavity. The pixel electrode 191 and the common electrode 270 are formed on the same layer (plane) under the liquid crystal layer 3, such that the liquid crystal molecules 310 are arranged by the horizontal electric field. The common electrode 270 is positioned on the microcavity, such that a problem of a height change according to the structure of the microcavity may be eliminated. The microcavity 305 is not formed on the data line 172, such that coupling generated between the common electrode 270 and the data line 172 may be reduced.

As compared to the embodiment of FIG. 1, in the exemplary embodiment of FIG. 16, the color filters 230 are formed under the sacrificial layer 300 and the microcavity. The color filters 230 are formed before the sacrificial layer 300. When the color filters 230 include the organic material, the bake process may be performed. However, the bake process hardens the material (for example, the photoresist material PR) forming the sacrificial layer 300, such that it may be difficult to wet etch the sacrificial layer 300. However, in the exemplary embodiment of FIG. 16, the sacrificial layer 300 is formed after forming the color filters 230, such that the is sacrificial layer 300 is not hardened and the wet etching is easy to perform.

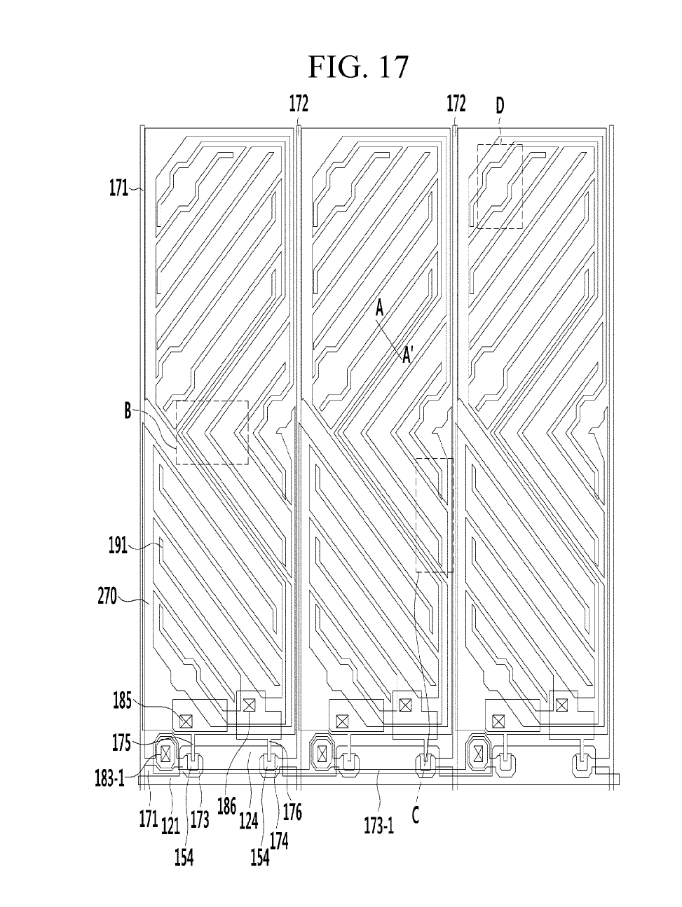

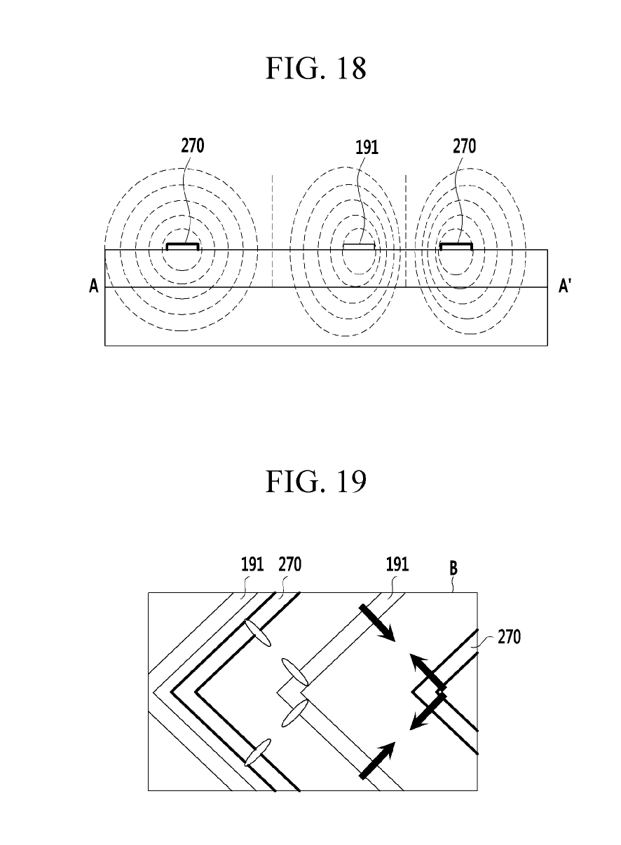

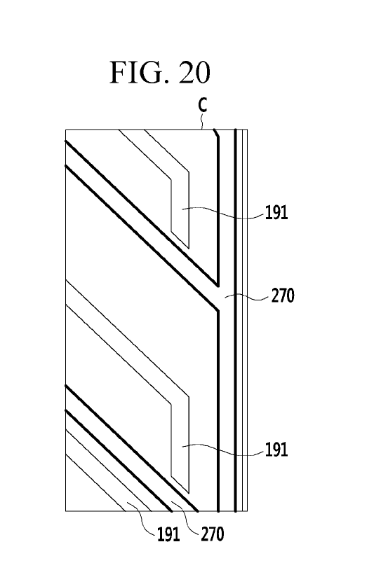

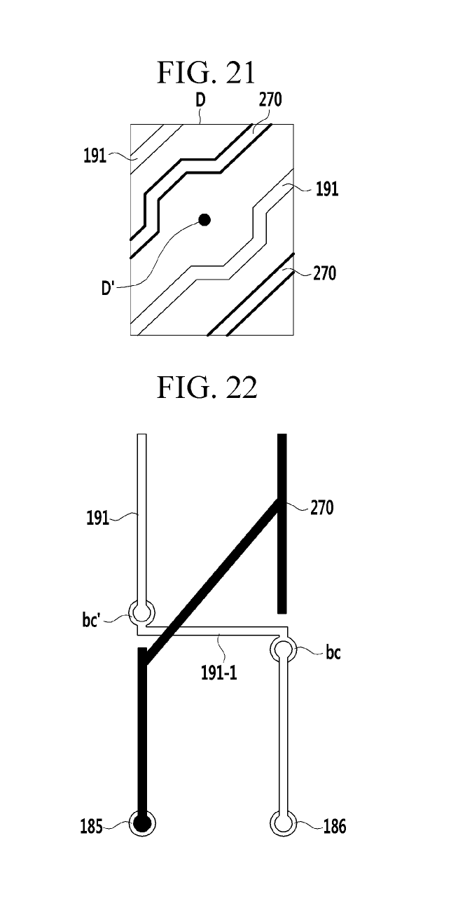

FIGS. 18, 19, 20, and 21 illustrate portions of the embodiment of FIG. 17. In particular, FIG. 18 illustrates a cross-section taken along line A-A′ of FIG. 17, FIG. 19 illustrates portion B of FIG. 17, FIG. 20 illustrates portion C of FIG. 17, and FIG. 21 illustrates portion D of FIG. 17.

Referring to FIG. 17, the gate lines 121 transmit the gate signal and extends in a mainly transverse direction. Each gate line 121 includes a gate electrode 124 that protrudes upward. The gate line 121 may have a single layer or a multilayer structure.

The gate insulating layer 140 (FIG. 1) is formed on the gate lines 121. A semiconductor 154 preferably made of hydrogenated amorphous silicon or polysilicon is formed on the gate insulating layer 140. The semiconductor 154 is positioned on the gate electrode 124, thereby forming the channel of the thin film transistor.

A pair of ohmic contacts (not shown) may be formed on the semiconductor 154. The ohmic contacts may be preferably made of n+ hydrogenated a-Si that is heavily doped with an N-type impurity such as phosphorous, or they may be made of a silicide.

A data conductor is formed on the gate insulating layer 140 and the semiconductor 154. The data conductor includes data lines 172, a first voltage transmitting line 171, first drain electrodes 176, and second drain electrodes 175. Each data line 172 transmits the data signal, extends mainly in the longitudinal direction, and is insulated from and crosses the gate line 121. The data line 172 includes a first source electrode 174 that has a U-shaped portion that curves toward the gate electrode 124.

The first voltage transmitting line 171 transmits the first voltage of a predetermined magnitude, extends parallel to the data line 172, and crosses and is insulated from is the gate line 121. The first voltage transmitting line 171 includes the second source electrode 173 that has a U-shaped portion that curves toward the gate electrode 124. The second source electrode 173 includes an expansion extending from the U-shaped portion and having a wide area.

When the liquid crystal display is configured to display three colors, one pixel includes three subpixels, as shown in FIG. 17. The subpixels receive a first voltage from the first voltage transmitting line 171. One of the subpixels (hereinafter referred to as a reference subpixel) adjacent to the first voltage transmitting line 171 is directly connected to the first voltage transmitting line 171 through the expansion of the second source electrode 173, and the second source electrodes 173 of the other subpixels (hereinafter referred to as connection subpixels) are connected through a connecting member 173-1. That is, the second source electrodes 173 of the connection subpixels receive the first voltage through the connecting member 173-1 connected to the expansion. The connecting member 173-1 may be formed from the same layer of material as the pixel electrode 191 or the common electrode 270. When displaying four colors, there may be one reference subpixel, and there may be three connection subpixels.

The first voltage transmitted through the first voltage transmitting line 171 may have the predetermined magnitude during one frame, and the polarity thereof may be changed in successive frames. For example, if a maximum voltage of the liquid crystal display is 15 V, the magnitude of the first voltage transmitted through the first voltage transmitting line 172 during the first frame may be 0 V, and the magnitude of the first voltage transmitted through the first voltage transmitting line 172 during a second frame after the first frame may be 15 V. In this case, if an arbitrary reference voltage is about 7.5 V, the first voltage transmitted by the first is voltage transmitting line 171 has a constant magnitude during one frame, and the polarity thereof may be changed per frame. However, the magnitude of the first voltage transmitted through the first voltage transmitting line 171 may be constant during a plurality of frames, and in this case, the polarity of the first voltage transmitted through the first voltage transmitting line 171 may be changed per the plurality of frames.

The first drain electrode 176 and the second drain electrode 175 include one end of a bar-type and the other end having a wide area. The bar-type ends of the first drain electrode 176 and the second drain electrode 175 are opposite to the first source electrode 174 and the second source electrode 173, with respect to the first gate electrode 124, and are partially enclosed by the curved portions of the first source electrode 174 and second source electrode 173. The wide ends are electrically connected to the common electrode 270 and the pixel electrode 191 through a first contact hole 186 and a second contact hole 185.

The gate electrode 124, the first source electrode 174, and the first drain electrode 176 form a first thin film transistor (TFT) along with the semiconductor 154. The channel of the first thin film transistor is formed in the semiconductor 154, between the first source electrode 174 and the first drain electrode 176. The first thin film transistor transmits the data voltage from the data line 172 to the pixel electrode 191.

The gate electrode 124, the second source electrode 173, and the second drain electrode 175 form a second thin film transistor along with the semiconductor 154. The channel of the second thin film transistor is formed in the semiconductor 154, between the second source electrode 173 and the second drain electrode 175. The second thin film transistor transmits the first voltage to the common electrode 270.

The data conductors 171, 172, 175, and 176 may have a single layer structure or a multilayer structure. The first passivation layer 180 is formed on the data conductors 171, 172, 175, and 176 and the exposed portion of the semiconductor 154. The first passivation layer 180 includes a plurality of contact holes 186 and 185 exposing the wide ends of the first drain electrode 176 and the second drain electrode 175, and a plurality of contact holes 183-1 exposing the expansion of the second source electrode 173.

The pixel electrodes 191 and the common electrodes 270 are made of a transparent conductive material, such as ITO (indium tin oxide) or IZO (indium zinc oxide), or of a reflective metal such as aluminum, silver, chromium, or alloys thereof. Each sub-pixel includes a pixel electrode 191 and a common electrode 270 pair.

As shown in FIG. 17, in each sub-pixel, the paired pixel electrode 191 and common electrode 270 occupy a generally rectangular area, and the pixel electrode 191 and the common electrode 270 are engaged with each other. The pixel electrode 191 and the common electrode 270 are symmetrical with respect to an imaginary transverse central line, and are respectively divided into two upper and lower sub-regions.

Each pixel electrode 191 includes a lower stem, an upper stem, and a plurality of branches extending from the lower stem and the upper stem. The common electrode 270 also includes a lower stem, an upper stem, and a plurality of branches extending from the lower stem and the upper stem. The lower stem and the upper stem of the pixel electrode 191 are disposed on the right side and the left side of one pixel electrode, respectively. The lower stem and the upper stem of the common electrode 270 are disposed on the right side and the left side of one pixel electrode, respectively.

Overlapping portions of the pixel electrode and the data line and the first voltage transmitting line, which are disposed on the left side and the right side of one subpixel electrode, is may be symmetrical on the left side and the right side of the pixel electrode. Therefore, the magnitudes of the parasitic capacitances between the pixel electrode 191 and the common electrode 270, and two left and right signal lines, may be the same. Thus, crosstalk generated by the deviation of the right and left parasitic capacitances may be prevented.

The angle formed between of the branches of the pixel electrode 191 and the common electrode 270 and the transverse center line may be about 45 degrees. The interval between the branches of the pixel electrode 191 and the common electrode 270 is generally within about 30 μm.

The branches of the pixel electrode 191 and the common electrode 270 engage with each other with a predetermined interval there between and are alternately disposed, thereby forming a pectinated (comb) pattern. A low gray region is formed where the interval between the neighboring branches is wide, and a high gray region is formed where the interval between the neighboring branches is narrow. The high gray region is disposed at the center of the pixel area and is enclosed by the low gray region.

In detail, referring to FIG. 18 and FIG. 19, in the case of the low gray region, the intensity of the electric field applied to the liquid crystal layer 3 between the branches of the pixel electrode 191 and the branches of the common electrode 270 is decreased, such that a relatively low gray level is displayed, even though the same voltage is applied to the high gray region, where the interval between the neighboring branches is narrow. Similarly, in the case of the high gray region, where the interval between the branches of the pixel electrode 191 and the branches of the common electrode 270 that are alternately disposed is narrow, the intensity of the electric field applied to the liquid crystal layer 3 between the branches of the pixel electrode 191 and the branches of the common electrode 270 is increased, such that the relatively high gray is level is displayed, even though the same voltage is applied as compared with the low gray region.

It is possible to vary the inclination angle of the liquid crystal molecules 310 of the liquid crystal layer 3 and display different luminances, with respect to one image information set, by varying the interval between the pixel electrode 191 and the common electrode 270 in one pixel. Further, it is possible to maximize the image viewing angle by properly adjusting the interval between the branches of the pixel electrode 191 and the common electrode 270. Therefore, it is possible to improve side visibility and enhance transmittance.

Referring to FIG. 20, the ends of the branches of the pixel electrode 191 may have a curved (bent) structure. Because of the curved structure of the branch of the pixel electrode 191, misalignment of the liquid crystal molecules 310 may be prevented in the corresponding regions, and the control force applied to the liquid crystal may be enhanced. The ends of the branches of the common electrode 270 may also have a curved (bent) structure.

Referring to FIG. 21, the portion D includes an expansion region D′ in which the interval between a branch of the pixel electrode 191 and a branch of the common electrode 270 is increased. The interval may be about 20 μm to about 28 μm. Due to the increased interval in the expansion region D′, the liquid crystal molecules 310 may not be influenced to have an irregular horizontal electric field, however the transmittance of the liquid crystal display may be reduced.

Accordingly, the intervals between the branches of the pixel electrode 191 and the branches of the common electrode 270 in the expansion region D′ may be changed in accordance with the transmittance of the liquid crystal display, along with the rotation degree of the liquid crystal molecules 310, according to the horizontal electric field. The expansion region D′ is is generally disposed at a position where the liquid crystal molecules are irregularly moved in the pixel area, such as a portion near the portion that is not enclosed by the stems of the pixel electrode 191 and the common electrode 270.

The liquid crystal molecules 310 disposed at the expansion region D′ are relatively weakly influenced by the horizontal electric field that is formed between the branches of the pixel electrode 191 and the common electrode 270. Accordingly, the liquid crystal molecules 310 disposed at the expansion region D′ are less influenced by the asymmetrical horizontal electric field, and the liquid crystal molecules 310 have a large tendency to maintain the initial vertical alignment state, such that the liquid crystal molecules may be prevented from being irregularly slanted by external pressure. Accordingly, irregular movements of the liquid crystal molecules, such as being diffused from the outer part of the pixel area to the inner part of the pixel area, are prevented. In addition, a singular point in the expansion region D′ is prevented from being formed, such that the quality deterioration of a large-sized display that flows from the outer part of the pixel area to the inner part of the pixel area may be prevented. According to various embodiments, the shape of the expansion region D′ may be different from the hexagonal structure of FIG. 21.

A ratio of the low gray region to the high gray region may be in a range of about 4:1 to about 30:1. Also, the interval between the branches of the pixel electrode 191 and the common electrode 270 may be about 10 μm to about 20 μm in the low gray region, and the interval between the branches of the pixel electrode 191 and the common electrode 270 in the high gray region may be about 3 μm to about 9 μm.

The low gray region may be disposed in a portion that is not enclosed by the stems of the pixel electrode 191 and the common electrode 270 (outer portion of the liquid is crystal display). The region is generally disposed where the magnitude of the horizontal electric field between the pixel electrode 191 and the common electrode 270 is relatively weak. Accordingly, display quality deterioration that can be generated by the asymmetry of the direction of the horizontal electric field between the pixel electrode 191 and the common electrode 270, such as texture, may be reduced.

The pixel electrode 191 is physically and electrically connected to the first drain electrode 176 through the contact hole 186, thereby receiving the data voltage from the first drain electrode 176. Also, the common electrode 270 is physically and electrically connected to the second drain electrode 175 through the contact hole 185, thereby receiving the first voltage from the second drain electrode 175 through the first voltage transmitting line 171 or the connecting member 173-1. The pixel electrode 191 and the common electrode 270 form a liquid crystal capacitor, in conjunction with the liquid crystal layer 3 disposed there between, thereby maintaining the applied voltage after the first thin film transistor and the second thin film transistor are turned off.

The microcavity is formed above the pixel electrode 191 and the common electrode 270 and below the roof layer 312. The liquid crystal layer is positioned inside the microcavity. Also, the light blocking member 220 and the color filter 230 may be formed on or under the pixel electrode 191 and the common electrode 270.

The shapes of the pixel electrodes 191 and the common electrodes 270 are not limited to the particular shapes disclosed herein. Therefore, all shapes in which at least portions of the pixel electrode 191 and the common electrode 270 are formed on the same layer and are alternately disposed may be included.

FIGS. 22 to 24 show arrangements of the pixel electrodes 191 and the common is electrodes 270 in a subpixel area having a rectangular structure. Referring to FIG. 22, the pixel electrode 191 includes linear portions that extend in the vertical direction and are positioned at a left upper side and a right lower side of the subpixel area. The portions are connected to a straight connection 191-1 that extends in the horizontal direction.

The common electrode 270 includes linear portions that extend in the vertical direction and are positioned at a left lower side and a right upper side of the subpixel area. The portions are connected by a connection that extends obliquely there between. By this structure, the magnitude of the parasitic capacitance formed by overlapping the data line and the first voltage transmitting line that are disposed on the left side and the right side of one pixel electrode and the pixel electrode may be symmetrical on the left side and the right side of the pixel electrode. As such, the magnitudes of the parasitic capacitances between the first pixel electrode 191 and the common electrode 270, and two left and right signal lines, may be the same, and crosstalk deterioration generated by the deviation of the right and left parasitic capacitances may be prevented.

The pixel electrode 191 and the common electrode 270 are formed on the same layer and are electrically separated from each other. However, the connections overlap and should be formed on different layers. In FIG. 22, the common electrode 270 is formed with the connection, however in the case of the pixel electrode 191, the connection 191-1 is formed on a different layer (i.e., from the same layer of material as the data line 172 or the gate line 121). The connection 191-1 is connected to the vertical portions by connections bc and bc′. The common electrode 270 receives the first voltage through the contact hole 185, and the pixel electrode 191 receives the data voltage through the contact hole 186. Based on the structure shown in FIG. 22, the branch electrodes are protruded, thereby realizing the structure of the pixel is electrode 191 and the common electrode 270.

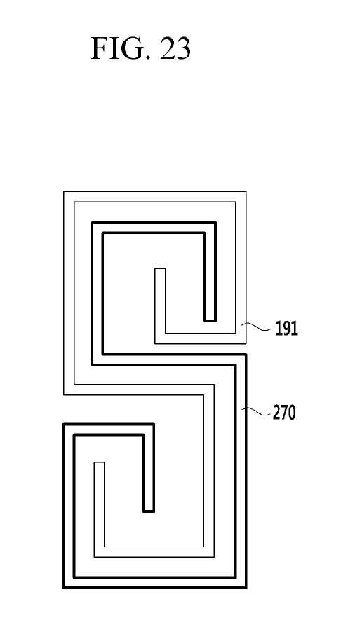

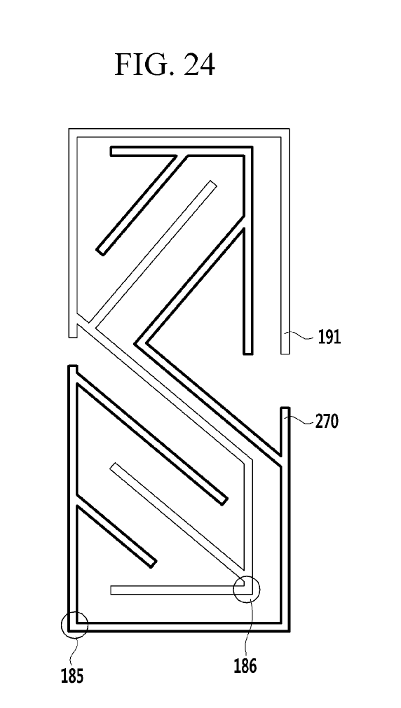

In FIG. 23, the pixel electrode 191 and the common electrode 270 have an S-shaped structure, and are separated by a predetermined interval. The pixel electrode 191 and the common electrode 270 do not overlap and may be formed from the same layer of material. Although not shown, the common electrode 270 receives the first voltage through the contact hole 185, the pixel electrode 191 receives the data voltage through the contact hole 186, and the positions of the contact holes 185 and 186 may be various. Based on the structure shown in FIG. 23, the branch electrodes are protruded thereby realizing the structure of the pixel electrode 191 and the common electrode 270.

In FIG. 24, the structure of the pixel electrode 191 and the common electrode 270 are simplified versions of the structure of FIG. 17. The pixel electrode 191 and the common electrode 270 are separated from each other with the predetermined interval, do not overlap, and are formed from the same layer of material. The common electrode 270 receives the first voltage through the contact hole 185, and the pixel electrode 191 receives the data voltage through the contact hole 186. Based on the structure shown in FIG. 24, the branch electrodes are protruded thereby realizing the structure of the pixel electrode 191 and the common electrode 270.

The pixel electrode 191 and the common electrode 270 configurations described above are exemplary only. Thus, the present invention encompasses other configurations.

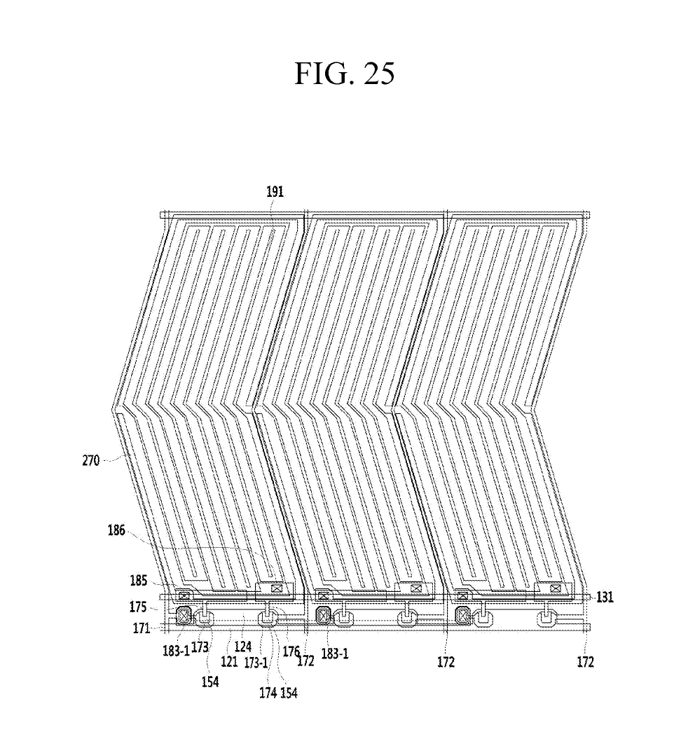

FIG. 25 is a layout view of a pixel structure of a liquid crystal display, according to another exemplary embodiment of the present invention. The liquid crystal display of FIG. 25 is similar to that of FIG. 17, so only the differences there between will be described in detail. Referring to FIG. 25, the pixel structure differs from that of FIG. 17, in that the pixel area has a V-shaped structure. As such, the data line 172, the first voltage transmitting line 171, the pixel is electrode 191, and the common electrode 270 also have V-shaped structures.

The liquid crystal display includes the liquid crystal layer 3 in the microcavity formed at the insulation substrate 110, and the pixel electrode 191 and the common electrode 270 with the same layer are formed under the microcavity.

A plurality of gate lines 121 and storage electrode lines 131 are formed on the insulation substrate 110. The gate line 121 transmits the gate signal and extends in a mainly transverse direction, and each gate line 121 includes a gate electrode 124 protruding in an upward direction.

The storage electrode line 131 is separated from the gate line 121 by a predetermined distance and extends in the transverse direction. The storage electrode line 131 overlaps the pixel electrode 191, thereby form a storage capacitor. The gate line 121 and the storage electrode line 131 may have the single layer or the multilayer structure.

A gate insulating layer 140 made of silicon nitride (SiNₓ) or silicon oxide (SiOₓ) is formed on the gate lines 121 and the storage electrode line 131. A semiconductor 154 preferably made of hydrogenated amorphous silicon or polysilicon is formed on the gate insulating layer 140. The semiconductor 154 is positioned on the gate electrode 124, thereby forming the channel of the thin film transistor.

A pair of ohmic contacts (not shown) may be formed on the semiconductor 154, according to various embodiments. The ohmic contacts may be made of n+ hydrogenated a-Si, which is heavily doped with an N-type impurity such as phosphorous, or they may be made of a silicide.

A data conductor is formed on the gate insulating layer 140 and the semiconductor 154. The data conductor includes the data lines 172, the first voltage is transmitting line 171, first drain electrodes 176, and second drain electrodes 175. The data lines 172 transmit the data signal, extend mainly in the longitudinal direction, and have the bent structure like the subpixel area. The data lines 172 are insulated from and cross the gate line 121. The data lines 172 include the curved first source electrodes 174.

The first voltage transmitting line 171 extends parallel to the data line 172 and has the bent structure thereby being insulated from and crossing the gate line 121. The first voltage transmitting line 171 includes the curved second source electrode 173. The second source electrode 173 includes an expansion extending from the curved portion and having a wide area.

When the liquid crystal display is configured to display three colors, one pixel includes three subpixels, as shown in FIG. 17. The subpixels receive a first voltage from the first voltage transmitting line 171. One of the subpixels (hereinafter referred to as a reference subpixel) adjacent to the first voltage transmitting line 171 is directly connected to the first voltage transmitting line 171 through the expansion of the second source electrode 173, and the second source electrodes 173 of the other subpixels (hereinafter referred to as connection subpixels) are connected through a connecting member 173-1. That is, the second source electrodes 173 of the connection subpixels receive the first voltage through the connecting member 173-1 connected to the expansion. The connecting member 173-1 may be formed from the same layer of material as the pixel electrode 191 or the common electrode 270. When displaying four colors, there may be one reference subpixel, and there may be three connection subpixels.

The first voltage transmitted through the first voltage transmitting line 171 may have the predetermined magnitude during one frame, and the polarity thereof may be changed in successive frames. For example, if a maximum voltage of the liquid crystal display is 15 V, the is magnitude of the first voltage transmitted through the first voltage transmitting line 172 during the first frame may be 0 V, and the magnitude of the first voltage transmitted through the first voltage transmitting line 172 during a second frame after the first frame may be 15 V. In this case, if an arbitrary reference voltage is about 7.5 V, the first voltage transmitted by the first voltage transmitting line 171 has a constant magnitude during one frame, and the polarity thereof may be changed per frame. However, the magnitude of the first voltage transmitted through the first voltage transmitting line 171 may be constant during a plurality of frames, and in this case, the polarity of the first voltage transmitted through the first voltage transmitting line 171 may be changed per the plurality of frames.

The first drain electrode 176 and the second drain electrode 175 each include one bar-type end and another end having a wide area. The bar-type ends of the first drain electrode 176 and the second drain electrode 175 are opposite to the first source electrode 174 and the second source electrode 173, with respect to the first gate electrode 124, and are partially enclosed by the curved first source electrode 174 and second source electrode 173. The wide ends are electrically connected to the common electrode 270 and the pixel electrode 191, through a first contact hole 186 and a second contact hole 185.

The gate electrode 124, the first source electrode 174, and the first drain electrode 176 form a first thin film transistor (TFT) along with the semiconductor 154. The channel of the first thin film transistor is formed in the semiconductor 154, between the first source electrode 174 and the first drain electrode 176. The first thin film transistor transmits the data voltage from the data line 172 to the pixel electrode 191.

The gate electrode 124, the second source electrode 173, and the second drain electrode 175 form a second thin film transistor along with the semiconductor 154. The channel is of the second thin film transistor is formed in the semiconductor 154, between the second source electrode 173 and the second drain electrode 175. The second thin film transistor transmits the first voltage to the common electrode 270.

The data conductors 171, 172, 175, and 176 may have a single layer or a multilayer structure. The first passivation layer 180 is formed on the data conductor 171, 172, 175, and 176 and the exposed portion of the semiconductor 154.

The first passivation layer 180 includes contact holes 186 and 185 exposing the wide ends of the first drain electrode 176 and the second drain electrode 175, and contact holes 183-1 exposing the expansion of the second source electrode 173.

As shown in FIG. 25, the entire outer shape of the pixel electrode 191 and the common electrode 270 has the bent structure, according to the shape of the subpixel, and the pixel electrode 191 and the common electrode 270 are engaged with each other. The pixel electrode 191 and the common electrode 270 are symmetrical with respect to an imaginary transverse central line, and are respectively divided into upper and lower sub-regions.

The pixel electrode 191 has a portion parallel to the data line 172 and has the bent structure. The common electrode 270 has a portion parallel to the data line 172 and has the bent structure. Also, the pixel electrode 191 and the common electrode 270 may include a connection extending parallel to the gate line 121 and connecting the parallel portions.

The common electrode 270 and the pixel electrode 191 may have portions that are not parallel to the data line 172. Also, the common electrode 270 and the pixel electrode 191 are separated from each other, and the interval there between may not be uniform.

The pixel electrode 191 is physically and electrically connected to the first drain electrode 176 through the contact hole 186, thereby receiving the data voltage from the first drain is electrode 176. The common electrode 270 is physically and electrically connected to the second drain electrode 175 through the contact hole 185, thereby receiving the first voltage from the second drain electrode 175 or the first voltage transmitted through the connecting member 173-1. The pixel electrode 191 and the common electrode 270 form a liquid crystal capacitor in conjunction with the liquid crystal layer 3 disposed there between, thereby maintaining the applied voltage after the first thin film transistor and the second thin film transistor are turned off.

The microcavity is positioned on the pixel electrode 191 and the common electrode 270. The microcavity is supported by the roof layer 312. The liquid crystal layer is positioned inside the microcavity. The light blocking member 220 and the color filter 230 may be formed, and in this case, they may be formed on or under the pixel electrode 191 and the common electrode 270.

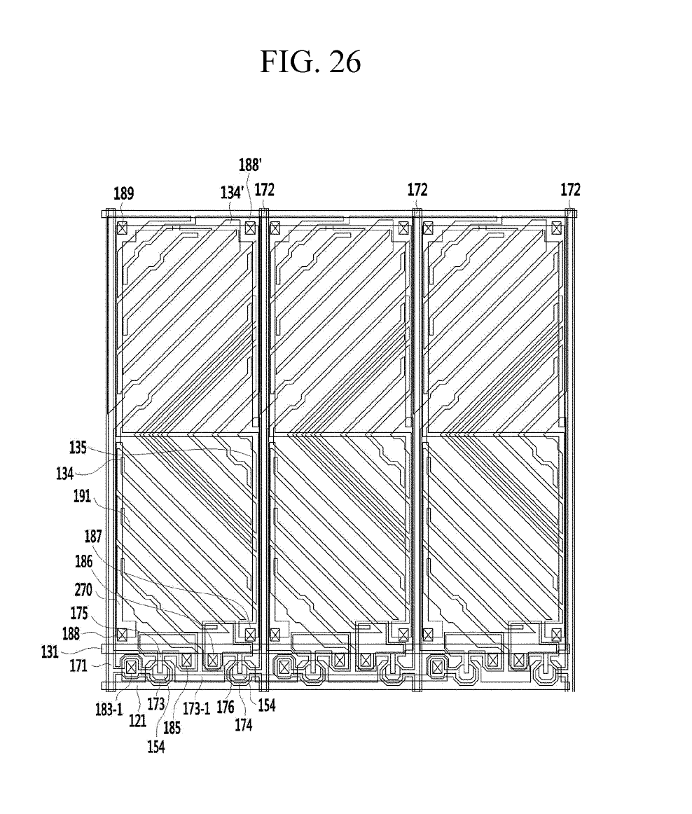

FIG. 26 is a layout view of a pixel structure of a liquid crystal display according to another exemplary embodiment of the present invention. The liquid crystal display is similar to the liquid crystal display of FIG. 25, so only the difference there between will be described in detail. Referring to FIG. 26, the liquid crystal display includes the liquid crystal layer 3 formed inside the microcavity formed on the insulation substrate 110, and the pixel electrode 191 and the common electrode 270 are formed with the same layer under the microcavity. This will be described in detail.

A plurality of gate conductors including a plurality of gate lines 121, a plurality of storage electrode lines 131, and connection conductors 134, 134′, and 135 are formed on an insulation substrate 110. The gate lines 121 transmit gate signals and extend in a transverse direction. Each gate line 121 includes a plurality of pairs of gate electrodes 124 protruding in an is upward direction.

The storage electrode lines 131 are applied with a predetermined voltage and mainly extend in the transverse direction. Each storage electrode line 131 is positioned between two neighboring gate lines 121 and is disposed adjacent to the lower gate line 121. Each storage electrode line 131 includes a plurality of pairs of protruding storage electrodes. The first connection conductors 134 and 134′ and the second connection conductor 135 are disposed at the edge and the center of the pixel area, and are respectively connected to the common electrode 270 and the pixel electrode 191.

The gate conductor may have a single layer or a multilayer structure. A gate insulating layer 140 made silicon nitride (SiNₓ) or silicon oxide (SiOₓ) is formed on the gate conductor.

A semiconductor 154 is made of hydrogenated amorphous silicon or polysilicon and is formed on the gate insulating layer 140. The semiconductor 154 is positioned on the gate electrode 124 thereby forming the channel of the thin film transistor.

A pair of ohmic contacts (not shown) may be formed on the semiconductor 154, according to an exemplary embodiment. The ohmic contacts may be made of n+ hydrogenated a-Si heavily doped with an N-type impurity such as phosphorous, or they may be made of a silicide.

A data conductor including a data line 172, the first voltage transmitting line 171, first drain electrodes 176, and second drain electrodes 175 are formed on the gate insulating layer 140 and the semiconductor 154. The data line 172 transmits the data signal and extends mainly in the longitudinal direction. The data line 172 is insulated from and crosses the gate line 121. The data line 172 includes the first source electrode 174.

The first voltage transmitting line 171 transmits the first voltage of a predetermined magnitude, and extends parallel to the data line 172. The first voltage transmitting line 171 is insulated from and crosses the gate line 121. The first voltage transmitting line 171 includes the second source electrode 173. The second source electrode 173 includes an expansion having a wide area.

When the liquid crystal display is configured to display three colors, one pixel includes three subpixels. The subpixels receive a first voltage from the first voltage transmitting line 171. One of the subpixels (hereinafter referred to as a reference subpixel) adjacent to the first voltage transmitting line 171 is directly connected to the first voltage transmitting line 171 through the expansion of the second source electrode 173, and the second source electrodes 173 of the other subpixels (hereinafter referred to as connection subpixels) are connected through a connecting member 173-1. That is, the second source electrodes 173 of the connection subpixels receive the first voltage through the connecting member 173-1 connected to the expansion. The connecting member 173-1 may be formed from the same layer of material as the pixel electrode 191 or the common electrode 270. When displaying four colors, there may be one reference subpixel, and there may be three connection subpixels.

The first voltage transmitted through the first voltage transmitting line 171 may have the predetermined magnitude during one frame, and the polarity thereof may be changed in successive frames. For example, if a maximum voltage of the liquid crystal display is 15 V, the magnitude of the first voltage transmitted through the first voltage transmitting line 172 during the first frame may be 0 V, and the magnitude of the first voltage transmitted through the first voltage transmitting line 172 during a second frame after the first frame may be 15 V. In this case, if an arbitrary reference voltage is about 7.5 V, the first voltage transmitted by the first is voltage transmitting line 171 has a constant magnitude during one frame, and the polarity thereof may be changed per frame. However, the magnitude of the first voltage transmitted through the first voltage transmitting line 171 may be constant during a plurality of frames, and in this case, the polarity of the first voltage transmitted through the first voltage transmitting line 171 may be changed per the plurality of frames.

The first drain electrode 176 and the second drain electrode 175 include one end of a bar-type and the other end having a wide area. The bar-type ends of the first drain electrode 176 and the second drain electrode 175 are opposite to the first source electrode 174 and the second source electrode 173, with respect to the first gate electrode 124, and are partially enclosed by the curved portions of the first source electrode 174 and second source electrode 173. The wide ends are electrically connected to the common electrode 270 and the pixel electrode 191 through a first contact hole 186 and a second contact hole 185.

The gate electrode 124, the first source electrode 174, and the first drain electrode 176 form the first thin film transistor (TFT), along with the semiconductor 154, and the channel of the first thin film transistor is formed in the semiconductor 154 between the first source electrode 174 and the first drain electrode 176. The first thin film transistor transmits the data voltage transmitted from the data line 172 to the pixel electrode 191.

The gate electrode 124, the second source electrode 173, and the second drain electrode 175 form the second thin film transistor, along with the semiconductor 154, and the channel of the second thin film transistor is formed in the semiconductor 154 between the second source electrode 173 and the second drain electrode 175. The second thin film transistor transmits the first voltage to the common electrode 270.

The data conductors 171, 172, 175, and 176 have a single layer or a multilayer structure. The first passivation layer 180 is formed on the data conductors 171, 172, 175, and 176 and the exposed portion of the semiconductor 154.

The first passivation layer 180 includes a plurality of contact holes 186 and 185 exposing the wide ends of the first drain electrode 176 and the second drain electrode 175, and a plurality of contact holes 183-1 exposing the expansion of the second source electrode 173. Also, the first passivation layer 180 and the gate insulating layer 140 have contact holes 188, 188′, and 189 exposing portions of the connection conductors 134, 134′, and 135.

A pixel electrode 191 and a common electrode 270 are paired in each subpixel region and are made of a transparent conductive material such as ITO (indium tin oxide) or IZO (indium zinc oxide), or a reflective metal such as aluminum, silver, chromium, or alloys thereof. The pixel electrode 191 and the common electrode 270 are engaged with each other and form a rectangular shape. The pixel electrode 191 and the common electrode 270 are symmetrical with respect to an imaginary transverse central line, and are respectively divided into upper and lower sub-regions.

Each pixel electrode 191 includes a lower stem, an upper stem, and a plurality of branches extending from the lower stem and the upper stem. The common electrode 270 also includes a lower stem, an upper stem, and a plurality of branches extending from the lower stem and the upper stem. The lower stem and the upper stem of the pixel electrode 191 are disposed on the right side and the left side of one pixel electrode, respectively. The lower stem and the upper stem of the common electrode 270 are disposed on the right side and the left side of one pixel electrode, respectively.

The lower stem and the upper stem of the pixel electrode 191 are separated, but are electrically connected by the first connection conductor 135. That is, the lower stem of the is pixel electrode 191 is connected to the first connection conductor 135 through the contact hole 187. The upper stem of the pixel electrode 191 is connected to the first connection conductor 135 through the contact hole 189, thereby receiving the voltage from the first drain electrode 176.

The lower stem and the upper stem of the common electrode 270 are connected directly to each other. However, they may be connected to the second connection conductors 134 and 134′ through the contact holes 188 and 188′. The second connection conductors 134 and 134′ do not connect the common electrode 270 and may be floated. The second connection conductors 134 and 134′ are disposed near the data line 172, the first voltage transmitting line 171, the pixel electrode 191 and the common electrode 270, such that the magnitudes of the parasitic capacitances may be symmetrical on the left side and the right side of the pixel electrode. As a result, the magnitudes of the parasitic capacitances between the pixel electrode 191 and the common electrode 270, and two left and right signal lines, may be the same. Thus, crosstalk deterioration generated by the deviation of the right and left parasitic capacitances may be prevented.

The angle of the branches of the pixel electrode 191 and the common electrode 270 with respect to the transverse center line may be about 45 degrees. The interval between the branches of the pixel electrode 191 and the common electrode 270 may be about 30 μm.

The branches of the pixel electrode 191 and the common electrode 270 engage with each other with a predetermined interval there between and are alternately disposed, thereby forming a pectinated (comb) pattern. A low gray region is formed where the interval between the neighboring branches is relatively wide, and a high gray region is formed where the interval between the neighboring branches is relatively narrow. The high gray region is disposed at the is center of the pixel area and is enclosed by the low gray region. In the case of the low gray region, the intensity of the electric field applied to the liquid crystal layer 3 between the branches of the pixel electrode 191 and the branches of the common electrode 270 is decreased, such that a relatively low gray level is displayed, even though the same voltage is applied, as compared with the high gray region where the interval between the neighboring branches is relatively narrow. Similarly, in the case of the high gray region, the intensity of the electric field applied to the liquid crystal layer 3 between the branches of the pixel electrode 191 and the branches of the common electrode 270 is increased, such that the relatively high gray is displayed even though the same voltage applied, as compared with the low gray region where the interval between the neighboring branches is wide.

It is possible to vary the inclination angle of the liquid crystal molecules 310 of the liquid crystal layer 3 and display different luminances with respect to one image information set, by varying the interval between the pixel electrode 191 and the common electrode 270 in one pixel. Further, it is possible to maximize the image viewing angle by adjusting the interval between the branches of the pixel electrode 191 and the common electrode 270. Therefore, it is possible to improve side visibility and enhance transmittance.

The ends of the branches of the pixel electrode 191 may have the curved (bent) structure. By the curved structure of the branch of the pixel electrode 191 prevents the misalignment of the liquid crystal molecules 310 in the corresponding regions, and enhances the control force applied to the liquid crystal. The ends of the branches of the common electrode 270 may also have the bent structure.

Expansion regions, in which the intervals between the branches of the pixel electrode 191 and the branches of the common electrode 270 are increased, may be provided. The expansion regions are as described above, thus a detailed description thereof will not be repeated.

In the liquid crystal display according to the present exemplary embodiment, a ratio of the low gray region and the high gray region may be in a range of about 4:1 to about 30:1. Also, the interval between the branches of the pixel electrode 191 and the common electrode 270 may be about 10 μm to about 20 μm in the low gray region, and the interval between the branches of the pixel electrode 191 and the common electrode 270 may be about 3 μm to about 9 μm in the high gray region.

The low gray region may be disposed in a portion that is not enclosed by the stems of the pixel electrode 191 and the common electrode 270. The region is generally disposed where the magnitude of the horizontal electric field between the pixel electrode 191 and the common electrode 270 is relatively weak is disposed. Accordingly, a display quality deterioration that can be generated by the asymmetry of the direction of the horizontal electric field between the pixel electrode 191 and the common electrode 270 such as texture may be reduced.

The pixel electrode 191 is physically and electrically connected to the first drain electrode 176 through the contact hole 186, thereby receiving the data voltage from the first drain electrode 176. Also, the common electrode 270 is physically and electrically connected to the second drain electrode 175 through the contact hole 185, thereby receiving the first voltage from the second drain electrode 175 or the first voltage transmitted through the connecting member 173-1. The pixel electrode 191 and the common electrode 270 form a liquid crystal capacitor in conjunction with the liquid crystal layer 3 disposed there between, thereby maintaining the applied voltage after the first thin film transistor and the second thin film transistor are turned off. The wide end of the first drain electrode 176 and the second drain electrode 175 connected to the pixel electrode 191 and the common electrode 270 overlaps the storage electrode via the gate insulating layer 140 thereby forming the storage capacitor, and the storage capacitor may enhance a voltage-maintaining capacity of the liquid crystal capacitor.

The microcavity is positioned on the pixel electrode 191 and the common electrode 270 and below the roof layer 312. The liquid crystal layer 3 is positioned inside the microcavity. Also, the light blocking member 220 and the color filters 230 may be formed on or under the pixel electrode 191 and the common electrode 270.

In the exemplary embodiment of FIG. 26, the number of the contact holes is larger than in the exemplary embodiment of FIGS. 17 and 25. When forming the color filter 230 or the light blocking member 220 under the pixel electrode 191 and the common electrode 270, the manufacturing process may be difficult. This is because the forming of the contact hole in the light blocking member 220 or the color filter 230 may be difficult. However, the difficulty of the process may be solved by previously forming the contact hole in the light blocking member 220 or the color filter 230, such that the exemplary embodiment of FIG. 26 is included in the present invention even though the light blocking member 220 or the color filter 230 is formed under the pixel electrode 191 and the common electrode 270.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display comprising:
a substrate;
a microcavity disposed on the substrate;
a pixel electrode and a common electrode disposed in the microcavity;
a liquid crystal layer disposed in the microcavity.

2. The liquid crystal display of claim 1, wherein the pixel electrode and the common electrode are coplanar.

3. The liquid crystal display of claim 1, wherein the pixel electrode and the common electrode are formed from the same layer of material.

4. The liquid crystal display of claim 1, wherein the pixel electrode and the common electrode each comprise branches that are parallel to each other.

5. The liquid crystal display of claim 4, wherein adjacent pairs of the branches are separated by different intervals.

6. The liquid crystal display of claim 4, wherein the pixel electrode and the common electrode each comprise a stem from which the branches extend.

7. The liquid crystal display of claim 6, wherein at least one of the stems and the branches is bent.

8. The liquid crystal display of claim 6, wherein an adjacent pair of the branches are bent to form an expansion region where the interval between the branches is increased.

9. The liquid crystal display of claim 1, further comprising a color filter disposed under the substrate, the pixel electrode, and the common electrode, or on the microcavity.

10. The liquid crystal display of claim 1, further comprising a light blocking member disposed under the insulation substrate, the pixel electrode, and the common electrode or on the microcavity.

11. The liquid crystal display of claim 1, further comprising a roof layer forming an upper surface of the microcavity.

12. A method of manufacturing a liquid crystal display, comprising:
forming a pixel electrode and a common electrode on a substrate;
forming a sacrificial layer on the pixel electrode and the common electrode;
forming a roof layer on the sacrificial layer;
forming a liquid crystal injection hole that exposes the sacrificial layer;
removing at least a portion of the sacrificial layer through the liquid crystal injection hole to form a microcavity; and
injecting a liquid crystal in the microcavity.

13. The method of claim 12, wherein in the pixel electrode and the common electrode are formed from the same layer of material.

14. The method of claim 12, further comprising forming a lower insulating layer comprising an inorganic insulating material on the sacrificial layer, before forming the roof layer.

15. The method of claim 12, wherein the pixel electrode and the common electrode each comprise branches that extend parallel to each other.

16. The method of claim 15, wherein adjacent pairs of the branches are separated by different intervals.

17. The method of claim 15, wherein the pixel electrode and the common electrode each comprise stems and branches extending from the stems.

18. The method of claim 17, wherein an adjacent pair of the branches are bent to form an expansion region where the interval between the branches is increased.

19. The method of claim 12, further comprising forming a color filter under the insulation substrate, the pixel electrode, and the common electrode, or on the microcavity.

20. The method of claim 12, further comprising forming a light blocking member under the insulation substrate, the pixel electrode, and the common electrode, or on the microcavity.
